(19) United States
(12) Patent Application Publication
(10) Pub. No.: US 2002/0028061 A1
(43) Pub. Date: Mar. 7, 2002

(54) Method and apparatus of processing video coding bit stream, and medium recording the programs of the processing

(76) Inventors: Seiichi Takeuchi, Osaka (JP); Masakazu Nishino, Osaka (JP)

Correspondence Address: RATNER AND PRESTIA, One Westlakes, Berwyn, Suite 301, P.O. Box 980, Valley Forge, PA, 19482-0980, US

(21) Appl. No.: 09/859,159

(22) Filed: May 16, 2001

(30) Foreign Application Priority Data
May 16, 2000 (JP) 2000-142863

(51) Int. Cl. H04N 5/783

(52) U.S. Cl. 386/68; 386/111

(57) ABSTRACT

Satisfying the standard regulation of the coded video system, the bit rate of the coded video bit stream is curtailed, by keeping the same display time, without decoding.

After curtailing part of coded frame of the coded video bit stream, a dummy P frame of which all motion vectors are vectors from forward reference frame and all DCT coefficients are 0 is inserted. At least one of a flag indicating the repeated reproduction frequency in the picture header of part or whole of coded frames in the coded video bit stream after insertion, or a flag indicating the frame rate in the sequence header of the coded video bit stream is rewritten.

### BACKGROUND OF THE INVENTION

1. Field of the Invention

The present invention relates to a method and apparatus for decreasing the bit rate of coded video bit stream by intra-frame coding or inter-frame coding. More particularly, it relates to a method and apparatus for decreasing the bit rate without decoding the coded data by satisfying the standard regulation of the intended coded video bit stream, and medium recording such program.

2. Description of the Related Art

Known video coding methods include MPEG1 (ISO/IEC11172), MPEG2 (ISO/IEC13818-2), MPEG 4 (ISO/IEC14496-2), and others.

A video distribution system has been hitherto proposed for storing coded video bit streams obtained by these video coding methods at the transmission side and distributing to the reception side. As far as the transmission route has a sufficient transmission band, the coded video bit streams stored at the transmission side can be transmitted. However, if the transmission band of the transmission route is insufficient, the bit rate is curtailed before transmission.

Several methods have been already proposed for curtailing the bit rate of the coded video bit streams.

For example, Japanese Laid-open Patent No. 7-222146 discloses a method for curtailing the bit rate by decoding part or whole of bit stream, and re-coding at different frame rate and bit rate.

Besides, in video data distributing apparatus and system, WO98/38798 Publication discloses, relating to MPEG bit streams having intra-frame coded picture (I picture), forward predicting coded picture (P picture) and both-direction predicting coded picture (B picture), a distribution method by deleting B picture and P picture when the network load is large.

Further, Japanese Laid-open Patent No. 10-42295 and Japanese Laid-open Patent No. 11-177986 disclose a method of decimating B picture, and creating and inserting B picture of zero inter-frame differential information instead of the decimated B picture, and a method of decimating P picture, and creating and inserting P picture of zero inter-frame differential information instead of the decimated P picture.

However, in the method disclosed in Japanese Laid-open Patent No. 7-222146, since part or whole of bit stream is once decoded and coded again, the image quality deteriorates. It requires encoder and decoder, and the apparatus cost is high. In order to obtain real-time performance, especially, the apparatus is realized by the hardware, and the degree of freedom of apparatus design is limited.

In the apparatus and method disclosed in WO98/38798 Publication, since a special low bit rate (LBR) header is added to the bit stream created by deleting B picture and P picture, an extra decoder is needed for this purpose. In the MPEG decoder of standard regulation, a moving image of at least same speed as in the original bit stream cannot be obtained.

In the apparatus and method disclosed in Japanese Laid-open Patent No. 10-42295 and Japanese Laid-open Patent No. 11-177986, if B picture is included in the original bit stream, this B picture is replaced by B picture of zero differential information. That is, the receiving side decoder is required to be applicable to B picture. Therefore, at the receiving side, the system cannot be built up by using simple decoders of I picture and P picture only. In other words, if attempted to build up the system by using simple decoders of I picture and P picture only at the receiving side, the bit streams accumulated at the transmitting side are limited only to those not containing B picture. That is, various vide materials archived in the format of coded video bit stream cannot be utilized sufficiently.

General terms differ in individual video coding systems, but correspond to each other substantially. For example, the picture in MPEG1 and MPEG2 corresponds to the VOP (video object plane) in MPEG4.

In this specification, the picture and VOP are commonly called the frame. The intra-frame coded picture or VOP is called I frame, forward predicting coded picture or VOP is P frame, and both-direction predicting coded picture or VOP is B frame.

The header describing various related information of each coded frame is called the frame header. In MPEG1 and MPEG2, it is called the picture header.

Further, the header describing general information relating to coded video bit stream created by each system is called the stream header. In MPEG1 and MPEG2, it is called the sequence header.

### SUMMARY OF THE INVENTION

The invention is devised in the light of the prior arts, and the processing method of coded video bit stream of the invention comprises: (a) a step of creating a second coded video bit stream by deleting a part of frames in a first coded video bit stream; and at least one of (b) a step of rewriting a flag indicating a repeat display frequency in a frame header of the second coded video bit stream and (c) a step of rewriting a flag indicating a frame rate in the stream header of the second coded video bit stream.

The processing apparatus of coded video bit stream of the invention comprises: (a) first means for creating a second coded video bit stream by deleting a part of frames in a first coded video bit stream; and at least one of (b) second means for rewriting a flag indicating a repeat display frequency in the frame header of the second coded video bit stream and (c) third means for rewriting a flag indicating a frame rate in the stream header of the second coded video bit stream.

The recording medium storing the coded video bit stream processing program of the invention comprises: (a) a program of creating a second coded video bit stream by deleting a part of frames in a first coded video bit stream; and at least one of (b) a program of rewriting a flag indicating a repeat display frequency in the frame header of the second coded video bit stream and (c) a program of rewriting a flag indicating a frame rate in the stream header of the second coded video bit stream.

### BRIEF DESCRIPTION OF THE DRAWINGS

FIG. 1 is a block diagram of coded video bit stream processing apparatus in embodiment 1 of the invention;

FIG. 2 is an operation timing chart showing a first operation example of coded video bit stream processing apparatus in embodiment 1 of the invention;

FIG. 3 is an operation timing chart showing a second operation example of coded video bit stream processing apparatus in embodiment 1 of the invention;

FIG. 4 is a block diagram of coded video bit stream processing apparatus in embodiment 2 of the invention;

FIG. 5 is an operation timing chart showing a first operation example of coded video bit stream processing apparatus in embodiment 2 of the invention;

FIG. 6 is an operation timing chart showing a second operation example of coded video bit stream processing apparatus in embodiment 2 of the invention;

FIG. 7 is a block diagram of coded video bit stream processing apparatus in embodiment 3 of the invention;

FIG. 8 is an operation timing chart showing an operation example of coded video bit stream processing apparatus in embodiment 3 of the invention;

FIG. 9 is a block diagram of coded video bit stream processing apparatus in embodiment 4 of the invention;

FIG. 10 is an operation timing chart showing an operation example of coded video bit stream processing apparatus in embodiment 4 of the invention;

FIG. 11 is a block diagram of coded video bit stream processing apparatus in embodiment 5 of the invention;

FIG. 12 is an operation timing chart showing a first operation example of coded video bit stream processing apparatus in embodiment 5 of the invention;

FIG. 13 is an operation timing chart showing a second operation example of coded video bit stream processing apparatus in embodiment 5 of the invention;

FIG. 14 is an operation timing chart showing a third operation example of coded video bit stream processing apparatus in embodiment 5 of the invention;

FIG. 15 is an operation timing chart showing a fourth operation example of coded video bit stream processing apparatus in embodiment 5 of the invention;

FIG. 16 is an operation timing chart showing a fifth operation example of coded video bit stream processing apparatus in embodiment 5 of the invention;

FIG. 17 is an operation timing chart showing a sixth operation example of coded video bit stream processing apparatus in embodiment 5 of the invention;

FIG. 18 is an operation timing chart showing a seventh operation example of coded video bit stream processing apparatus in embodiment 5 of the invention;

FIG. 19 is an operation timing chart showing an eighth operation example of coded video bit stream processing apparatus in embodiment 5 of the invention;

FIG. 20 is an operation timing chart showing a ninth operation example of coded video bit stream processing apparatus in embodiment 5 of the invention;

FIG. 21 is a block diagram of coded video bit stream processing apparatus in embodiment 6 of the invention;

FIG. 22 is an operation timing chart showing a first operation example of coded video bit stream processing apparatus in embodiment 6 of the invention;

FIG. 23 is an operation timing chart showing a second operation example of coded video bit stream processing apparatus in embodiment 6 of the invention;

FIG. 24 is a block diagram of coded video bit stream processing apparatus in embodiment 7 of the invention;

FIG. 25 is an operation timing chart showing an operation example of coded video bit stream processing apparatus in embodiment 7 of the invention;

FIG. 26 is a block diagram of coded video bit stream processing apparatus in embodiment 8 of the invention;

FIG. 27 is an operation timing chart showing an operation example of coded video bit stream processing apparatus in embodiment 8 of the invention; and

FIG. 28 is a data composition diagram of dummy P frame.

### DESCRIPTION OF THE PREFERRED EMBODIMENTS

(Embodiment 1)

A coded video bit stream processing apparatus in embodiment 1 of the invention is explained.

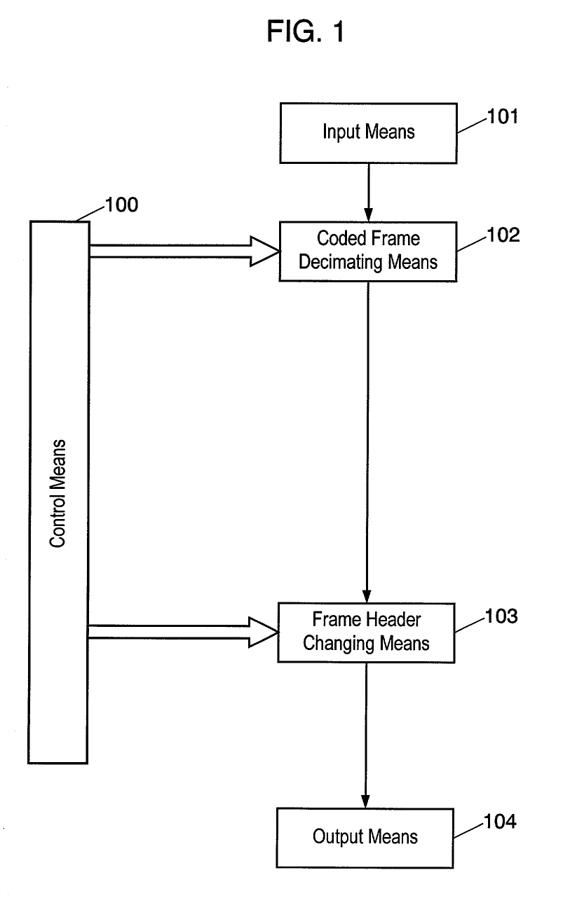

FIG. 1 is a block diagram of coded video bit stream processing apparatus in embodiment 1 of the invention.

In FIG. 1, input means 101 supplies a coded video bit stream as the object of bit rate curtailment from outside into coded frame decimating means 102.

The coded frame decimating means 102, according to an instruction from control means 100, curtails part of I frame, whole or part of P frame, and whole or part of B frame, from the supplied coded video bit stream.

Frame header changing means 103, according to an instruction from the control means 100, rewrites a flag indicating the number of times of repeated displays in a picture header of part or whole of coding frame of the coded video bit stream issued from the coded frame decimating means 102.

Output means 104 issues the coded video bit stream obtained by the frame header changing means 103 to outside.

The control means 100 controls the coded frame decimating means 102 and frame header changing means 103 so that the display time of the moving image decoded from the coded video bit stream issued from the output means 104 may be nearly equal to the display time of decoding the coded video bit stream entered from the input means 101. At this time, the control means 100 controls them so that the coded video bit stream issued from the output means 104 may satisfy the standard of MPEG2.

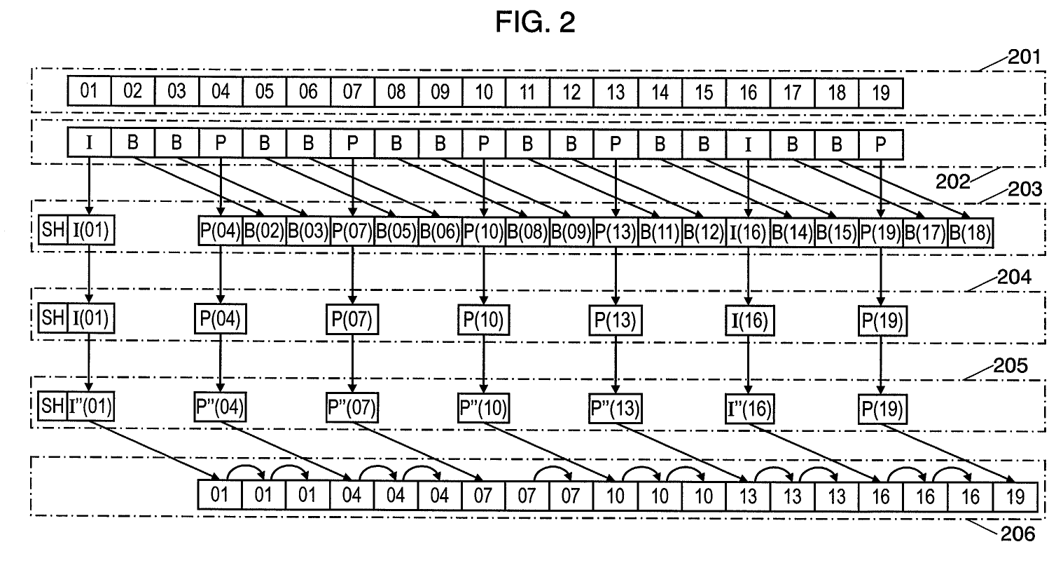

FIG. 2 is an operation timing chart showing a first operation example of coded video bit stream processing apparatus in embodiment 1.

A coded video bit stream 203 is a bit stream coded by MPEG2 system according to the coding type shown in coding type sequence 202, from each frame of moving image 201 of progressive scanning type at frame rate of 60 Hz. The bit stream 203 is put into the input means 101.

For the convenience of explanation, in the moving image 201, division of each frame and frame number are shown. In the coding type sequence 202, the coding type selected when coding each frame of the moving image 201 is shown. “I” means intra-frame coding (I coding). “P” means forward prediction coding (P coding). “B” means both-direction prediction coding (B coding). The coded video bit stream 203 is composed of a sequence header (SH), and subsequent coded frames. For example, I (01) means that the first frame of the moving image 201 is an I-coded frame. P (04) means that the fourth frame of the moving image 201 is a P-coded frame. B (02) means that the second frame of the moving image 201 is a B-coded frame. Each coded frame is provided with a picture header (not shown).

In I coding and P coding, simultaneously with frame input, coding is processed, and a proper output is issued. In B coding, in order to refer to a frame in a backward direction, after coding of reference frame in backward direction, coding is processed and an output is issued. Accordingly, the frame sequence of input moving image and frame sequence after coding are different.

The coded frame decimating means 102 deletes B frames such as B (02), B (03), B (05), and B (06) from the coded video bit stream 203 according to the instruction from the control means 100, and issues a coded video bit stream 204.

At this moment, the quantity of data is decreased by the portion of the deleted B frames, and the bit rate is curtailed. Supposing, however, that this coded video bit stream 204 is decoded and displayed, as compared with the display speed by decoding and displaying the coded video bit stream 203, that is, as compared with the display speed of the moving image 201, it is displayed as if reproduced at triple speed.

Accordingly, the frame header changing means 103, according to an instruction from the control means 100, rewrites the flag indicating the frequency of repeating reproductions and displays of the frame included in the picture header of each coded frame for composing the coded video bit stream 204. Specifically, the values of Repeat_First_Field (RFF) and Top_Field_First (TFF) are changed.

In the case of progressive sequence, when the value of RFF is 0, the frequency of display of this frame is 1. When the value of RFF is 1 and the value of TFF is 0, the frequency of display of this frame is 2. Further, when the value of RFF is once and the value of TFF is 1, the frequency of display of this frame is 3 times.

In this example of operation, the values of both RFF and TFF of the picture header of each coded frame for composing the coded video bit stream 204 are changed to 1, and a coded video bit stream 205 is obtained.

The coded video bit stream 205 satisfies the standard of MPEG2. Further, the display time by decoding the coded video bit stream 205 is equal to the display time of the moving image 201.

The appendix (″) in each coded frame of the coded video bit stream 205 indicates that the values of both RFF and TFF are changed to 1.

When neither RFF nor TFF is entered, both values are handled as 0. That is, the frequency of display of coding frame is once. To set the frequency of reproduction and display to 2 or 3 times, the RFF and TFF are additionally entered in the picture header of the coded frame.

When the picture header is changed, the quantity of data is not increased. When additionally entered in the picture header, increase in the quantity of data can be ignored, and the data quantity saving effect by the coded frame decimating means 102 is maintained.

The coded video bit stream 205 is issued outside through the output means 104.

The moving image 206 shows a moving image displayed by decoding the coded video bit stream 205 outside.

Generally, when decoding and displaying the coded video bit stream, if I frame and P frame are entered in the decoding processing unit, decoding is processed appropriately. They are once held, without issuing for displaying immediately, and the decoded image of the I frame or P frame entered one step before is displayed. When the B frame is entered in the decoding processing unit, it is displayed immediately after the decoding process. By such processing, the sequence before coding is reproduced.

In the case of this operation, for example, when P″ (04) of the coded video bit stream is entered in an external decoding processing unit, the decoded image of the previously entered I″ (01) is displayed. This image I″ (01) is displayed 3 times because the values of both RFF and TFF are changed to 1. When P″ (07) is entered in the external decoding processing unit, the decoded image of P″ (04) is displayed. Similarly, the image P″ (01) is displayed 3 times because the values of both RFF and TFF are changed to 1.

Thus, the coded frame decimating means 102 deletes part of the coded frame, and the frame header changing means 103 changes the picture header so as to compensate for decrease in the duration of the reproduction and display time by the deleted coded frame, so that the bit rate of the entered coded video bit stream is curtailed.

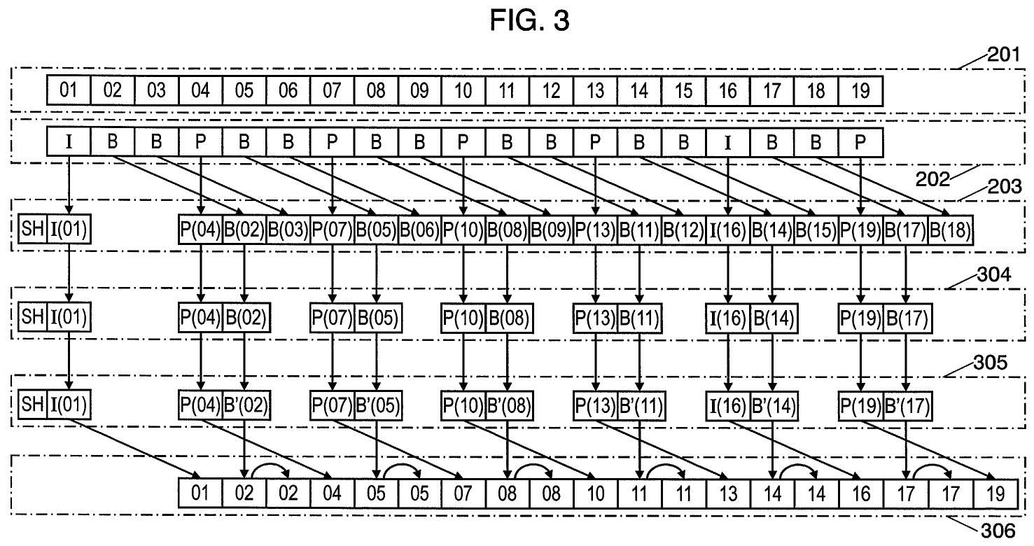

FIG. 3 is an operation timing chart showing a second operation example of coded video bit stream processing apparatus in embodiment 1. Same elements as in the foregoing example of operation are identified with same reference numerals. In this operation example, as compared with the operation example in FIG. 2, the operation of the coded frame decimating means 102 is different. That is, as shown in a coded video bit stream 304, part of the coded B frame is not decimated but is left over.

The frame header changing means 103 sets the values of RFF and TFF as follows. In the picture header of B (02), B (05), B (08) of the coded video bit stream 304, the value of RFF is set to 1 and the value of TFF is set to 0, and the coded video bit stream 305 is obtained.

The appendix (′) of each coded frame of the coded video bit stream 305 means that the value of RFF is 1 and that the value of TFF is 0.

The coded video bit stream 305 satisfies the standard of MPEG2. Further, the display time by decoding the coded video bit stream 305 is equal to the display time of the moving image 201.

The coded video bit stream 305 is issued outside through the output means 104.

The moving image 306 shows a moving image displayed by decoding the coded video bit stream 205 outside.

In the case of this operation, for example, when P (04) of the coded video bit stream is entered in an external decoding and display processing unit, decoding of P (04) is processed, and the decoded image is held temporarily. Then the decoded image of the previously entered I (01) is displayed. Since the picture header of I (01) is not changed, it is displayed once. When B′ (02) is entered in the decoding and display processing unit, the B′ (02) is decoded and displayed immediately. The B′ (02) is displayed twice because the picture header is changed and the frequency of reproduction and display is set as 2. When P (07) is entered, the decoded image of the previously entered P (04) is displayed.

As operation examples of embodiment 1 shown in FIG. 1, two operation examples are shown in FIG. 2 and FIG. 3, but the change of the picture header may be a mixture of 2 times and 3 times of the number of frequency of reproduction and display.

(Embodiment 2)

A coded video bit stream processing apparatus in embodiment 2 of the invention is explained.

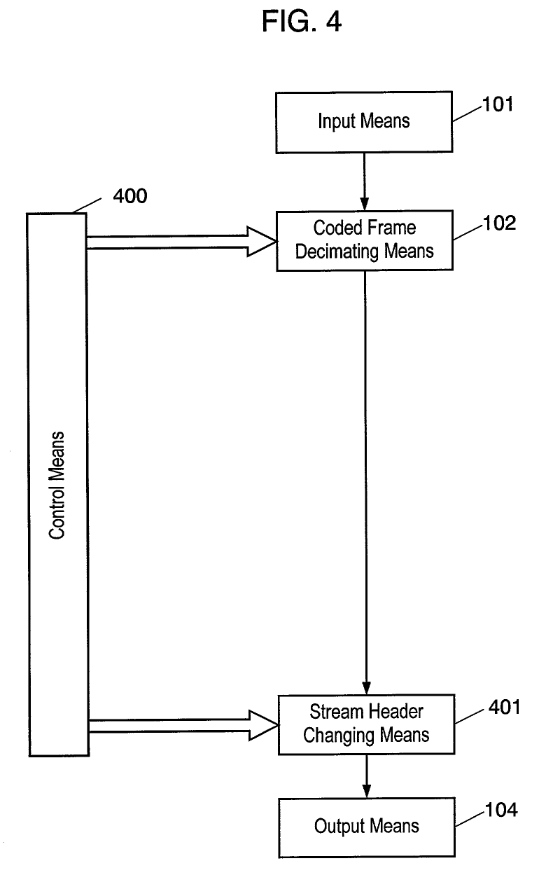

FIG. 4 is a block diagram of coded video bit stream processing apparatus in embodiment 2 of the invention. In this embodiment, the frame header changing means 103 shown in FIG. 1 is replaced with stream header changing means.

Stream header changing means 401, according to an instruction from control means 400, rewrites a flag indicating the frame rate in the sequence header of the coded video bit stream issued by coded frame decimating means 102.

Output means 104 issues the coded video bit stream obtained in the stream header changing means 401 to outside.

The control means 400 controls the coded frame decimating means 102 and stream header changing means 401 so that the display time of the moving image decoded from the coded video bit stream issued from the output means 104 may be nearly equal to the display time of the moving image decoded from the coded video bit stream entered from the input means 101. At this time, the control means 400 controls them so that the coded video bit stream issued from the output means may satisfy the standard of MPEG2.

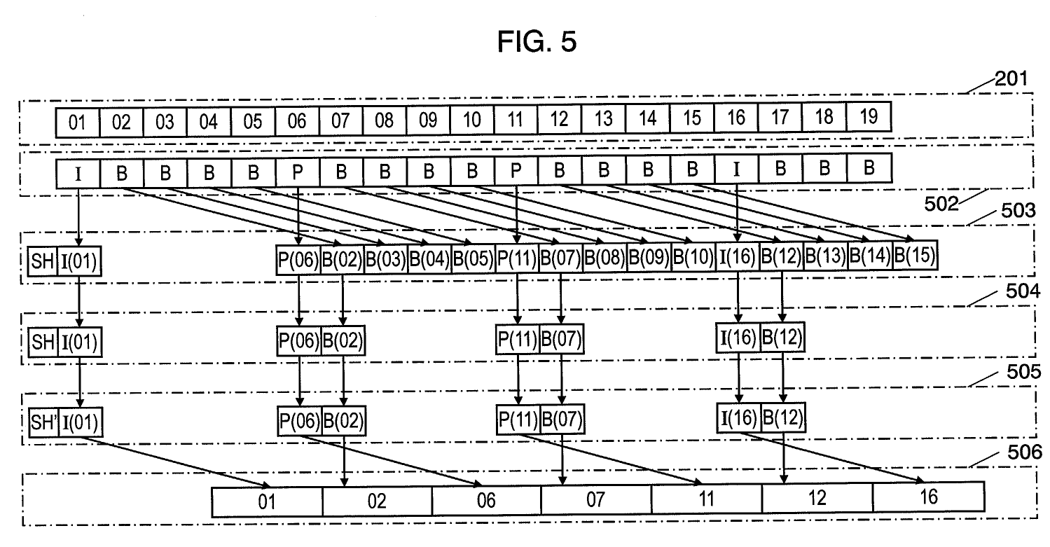

FIG. 5 is an operation timing chart showing a first operation example of coded video bit stream processing apparatus in embodiment 2.

A coded video bit stream 503 is a bit stream coded by MPEG2 system according to the coding type shown in coding type sequence 502, from each frame of moving image 201 of progressive scanning type at frame rate of 60 Hz, and it is put into the input means 101.

The coded frame decimating means 102 deletes B frames such as B (03), B (04), B (05), B (08), B (09), and B (10) from the coded video bit stream 503 according to the instruction from the control means 400, and issues a coded video bit stream 504.

That is, the coded frame decimating means 102 deletes a total of 36 coded frames from 60 coded frames per second. As a result, 24 coded frames are issued per second.

At this moment, the bit rate is curtailed, and supposing the coded video bit stream 504 is decoded and displayed, it is displayed as if reproduced at a fast rate of 5/2 times of the display speed of the moving image 201.

Accordingly, the stream header changing means 401, according to an instruction from the control means 400, rewrites the flag for indicating the frame rate in the sequence header (SH) of the coded video bit stream 504. More specifically, the value of Frame_Rate_Value (FRV) is changed. In the MPEG2 standard, there are seven frame rates, that is, 24/1.001 Hz, 24 Hz, 25 Hz, 30/1.001 Hz, 30 Hz, 60/1.001 Hz, and 60 Hz.

In the FRV of the sequence header (SH) of the coded video bit stream 503, a value corresponding to 60 Hz is set. The stream header changing means 401 changes the FRV to a value corresponding to 24 Hz according to the instruction from the control means 400.

That is, the control means 400 commands the coded frame decimating means 102 to delete a total of 36 coded frames from a total of 60 coded frames per second. Also, the control means 400 commands the stream header changing means 401 to set the value of FRV so as not to change for the display time by changing the frame rate. As a result, the coded video bit stream 505 satisfies the standard of MPEG2. Further, the display time by decoding the coded video bit stream 505 is equal to the display time of the moving image 201.

The appendix (′) attached to the sequence header (SH) of the coded video bit stream 505 shows the sequence header is changed as shown above.

The coded video bit stream 505 is issued outside through the output means 104.

The moving image 506 shows a moving image displayed by decoding the coded video bit stream 205 outside. That is, the first, second, sixth, seventh, 11th, 12th and 16th frames of the moving image 201 are sequentially displayed at equal intervals. That is, they are displayed at frame frequency of 24 Hz.

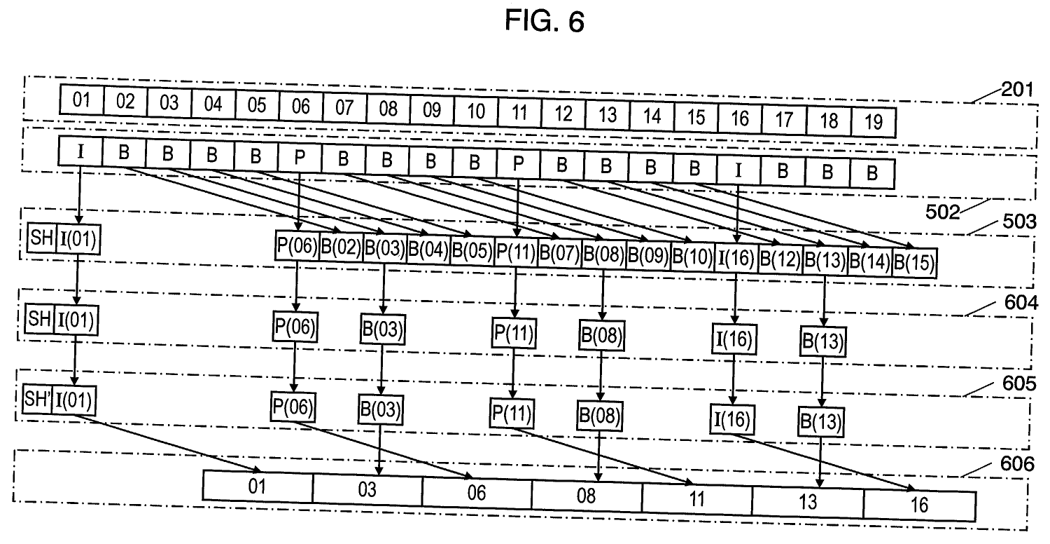

FIG. 6 is an operation timing chart showing a second operation example of coded video bit stream processing apparatus in embodiment 2.

Same elements as in the foregoing example of operation are identified with same reference numerals. In this operation example, as compared with the operation example in FIG. 5, the operation of the coded frame decimating means 102 is different.

The coded frame decimating means 102 deletes B frames such as B (02), B (04), B (05), B (07), B (09), and B (10) from the coded video bit stream 503, and issues a coded video bit stream 604.

That is, the coded frame decimating means 102 deletes a total of 36 frames from 60 coded frames per second, and 24 coded frames are issued per second.

Same as in the case of FIG. 5, the stream header changing means 401 changes the FRV in the sequence header (SH) of the coded video bit stream 604 to a value corresponding to 24 Hz.

A coded video bit stream 605 is issued outside through the output means 104.

A moving image 606 is displayed by decoding the coded video bit stream 605 outside. That is, the first, third, sixth, eighth, 11th, 13th and 16th frames of the moving image 201 are sequentially displayed at equal intervals.

In the operation example in FIG. 5, the frames are displayed in the sequence of the first, second, sixth, seventh, 11th, 12th, 16th, and so forth of the moving image 201, but in the operation example in FIG. 6, the frames are displayed in the sequence of the first, third, sixth, eighth, 11th, 13th, 16th, and so forth, and the motion of the displayed image is smoother.

Thus, by deleting part of the coded frames by the coded frame decimating means 102, the sequence header is changed by the stream header changing means 401 so as to compensate for the decrease of the duration of reproduction and display time by the deleted coded frames, and the bit rate of the entered coded video bit stream is curtailed.

In the operation examples in FIG. 5 and FIG. 6, only the FRV in the sequence header is changed when changing the instruction of frame rate, but it is not limited. In the case of MPEG2, aside from FRV, by changing together with frame_rate_extension_n and frame_rate_extension_d, various frame rates can be selected.

(Embodiment 3)

A coded video bit stream processing apparatus in embodiment 3 of the invention is explained.

Embodiment 3 is a combination of foregoing embodiment 1 and embodiment 2.

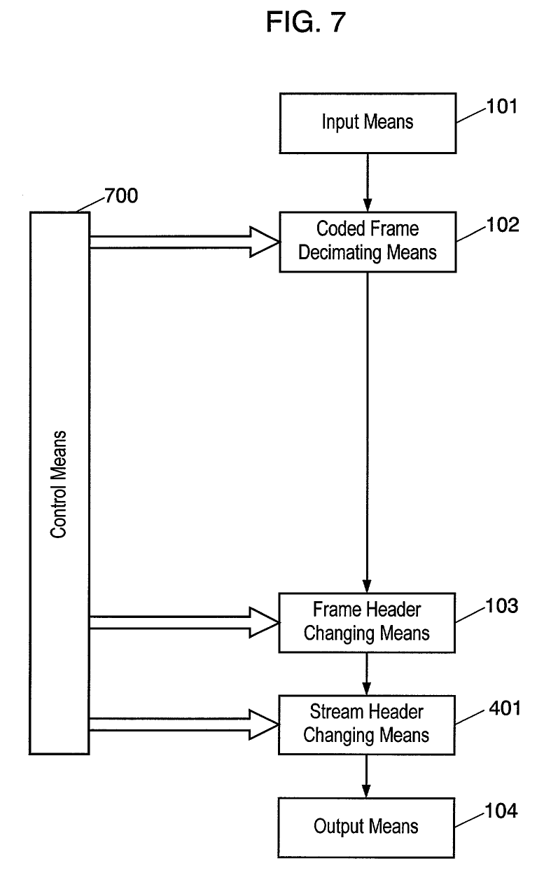

FIG. 7 is a block diagram of coded video bit stream processing apparatus in embodiment 3 of the invention. In this embodiment, stream header changing means 401 is further provided between the frame header changing means 103 and output means 104 shown in FIG. 1. In FIG. 7, same elements as shown in FIG. 1 are identified with same reference numerals.

The stream header changing means 401, according to an instruction from control means 700, rewrites a flag indicating the frame rate in the sequence header of the coded video bit stream issued by frame header changing means 103.

Output means 104 issues the coded video bit stream obtained from the stream header changing means 401 to outside.

The control means 700 controls the coded frame decimating means 102, frame header changing means 103, and sequence header changing means 401 so that the display time of the moving image decoded from the coded video bit stream issued from the output means 104 may be nearly equal to the display time of the moving image decoded from the coded video bit stream entered from the input means 101. At this time, the control means 700 controls them so that the coded video bit stream issued from the output means 104 may satisfy the standard of MPEG2.

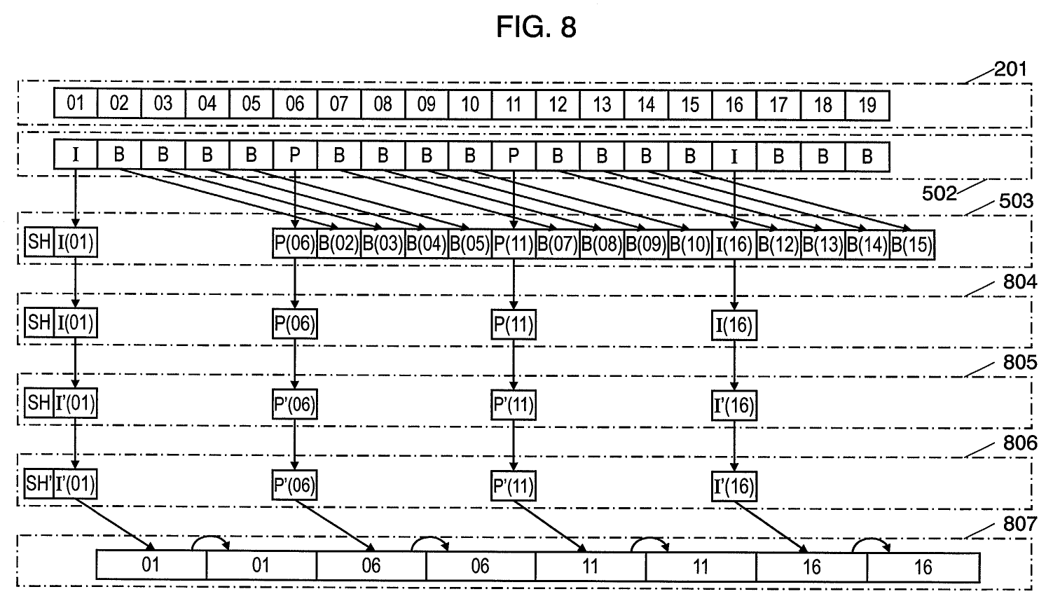

FIG. 8 is an operation timing chart showing an operation example of coded video bit stream processing apparatus in embodiment 3. In FIG. 8, same elements as in the foregoing operation examples are identified with same reference numerals.

The coded frame decimating means 102 deletes all B frames from the coded video bit stream 503 according to the instruction from the control means 700, and issues a coded video bit stream 804.

The frame header changing means 103 changes the picture header of each coded frame of the coded video bit stream 804 according to an instruction from the control means 700.

If the frequency of repeated reproductions of all coded frames of the coded video bit stream 804 are set at the maximum of 3 times, the display time cannot be adjusted to the display time of the moving image 201. Accordingly, the sequence header is also changed. Herein, the frame header changing means 103 sets the value of RFF to 1 and the value of TFF to 0 in the picture header of each coded frame of the coded video bit stream 804, and a coded video bit stream 805 is issued.

The stream header changing means 401 changes the FRV in the sequence header (SH) of the coded video bit stream 805 to a value corresponding to 24 Hz according to an instruction from the control means 700, and issues a coded video bit stream 806.

The coded video bit stream 806 is issued outside through the output means 104.

A moving image 807 is displayed by decoding the coded video bit stream 806, and the first, sixth, 11th, and 16th frames of the moving image 201 are displayed twice each sequentially at equal intervals. The display interval of each frame is set longer by the portion of change of the sequence header, and the time of moving image 807 is equal to the display time of the moving image 201.

In embodiment 1 and embodiment 2, in order to satisfy the MPEG2 standard while keeping nearly constant the display time after decoding, there is a limitation in the number of coded frames curtailed by the coded frame decimating means 102. Such limitation is alleviated in embodiment 3, and the bit rate curtailing effect is further obtained.

(Embodiment 4)

A coded video bit stream processing apparatus in embodiment 4 of the invention is explained.

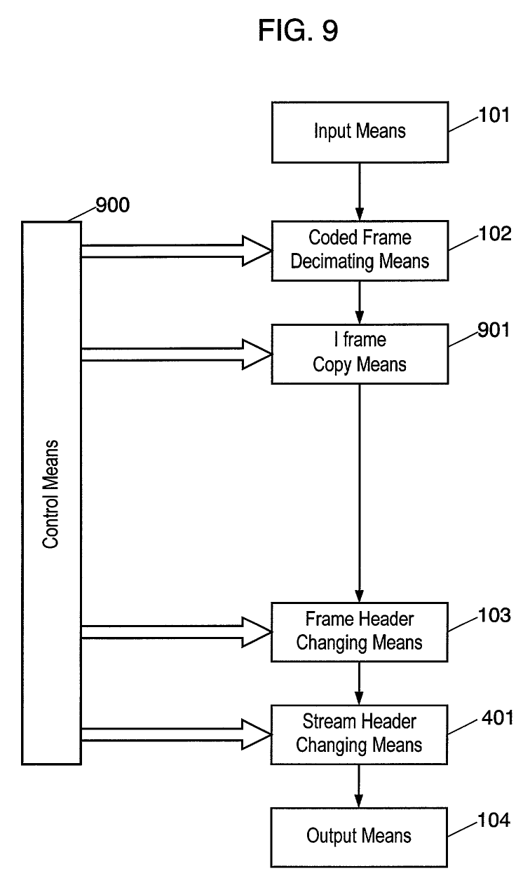

FIG. 9 is a block diagram of coded video bit stream processing apparatus in embodiment 4 of the invention. In this embodiment, between the coded frame decimating means 102 and frame header changing means 103 shown in FIG. 7, I frame copy means 901 is further provided. In FIG. 9, same elements as explained in FIG. 7 are identified with same reference numerals.

The I frame copy means 901 copies, inserts and issues the I frame existing ahead of the deleted coded frame in part of the position once occupied by the deleted coded frame, in the coded video bit stream issued from the coded frame decimating means 102.

The frame header changing means 103, according to an instruction from control means 900, rewrites a flag indicating the frequency of repeated reproductions in a picture header of part or whole of coded frame of the coded video bit stream issued from the I frame copy inserting means 901.

The control means 900 controls the coded frame decimating means 102, I frame copy means 901, frame header changing means 103, and sequence header changing means 401 so that the display time of the moving image decoded from the coded video bit stream issued from the output means 104 may be nearly equal to the display time of the moving image decoded from the coded video bit stream entered from the input means 101. At this time, the control means 900 controls them so that the coded video bit stream issued from the output means 104 may satisfy the standard of MPEG2.

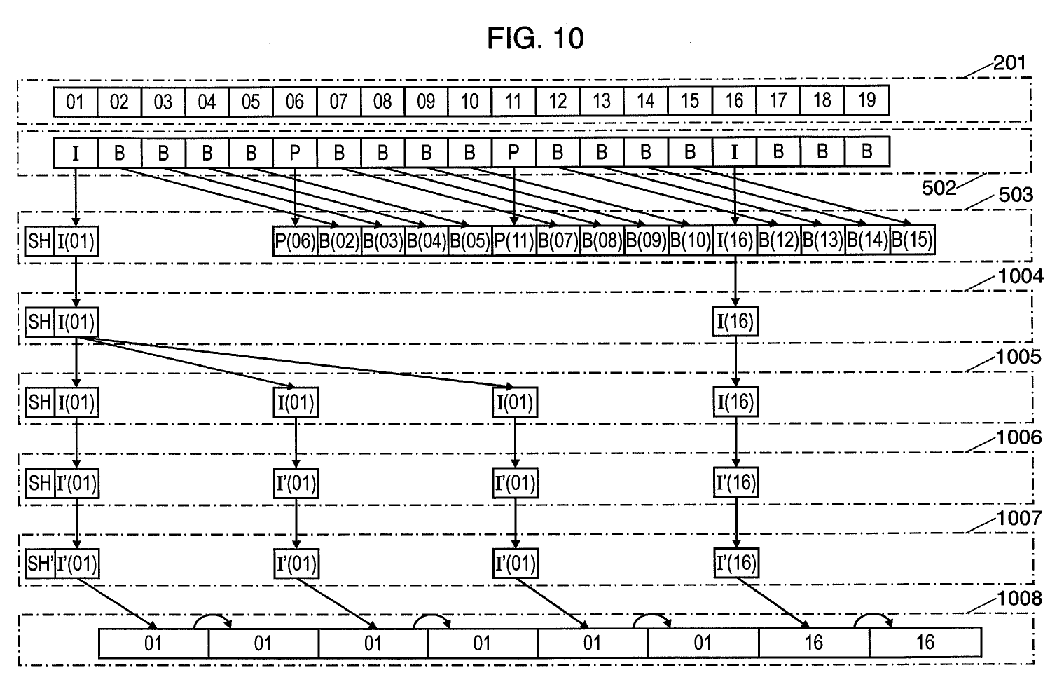

FIG. 10 is an operation timing chart showing an operation example of coded video bit stream processing apparatus in embodiment 4. In FIG. 10, same elements as in the foregoing operation examples are identified with same reference numerals.

The coded frame decimating means 102 deletes all P frames and B frames from the coded video bit stream 503 according to an instruction from the control means 900, and issues a coded video bit stream 1004.

The I frame copy means 901, according to an instruction from the control means 900, copies and inserts the I frame existing ahead of the P frame at the position once occupied by the P frame in the coded video bit stream 503, in the coded video bit stream 1004. That is, a copy of I (01) is inserted into the position once occupied by P (06), P (11), and a coded video bit stream 1005 is obtained.

The frame header changing means 103, according to an instruction from the control means 900, sets the value of RFF to 1 and the value of TFF to 0 in the picture header of each coded frame of the coded video bit stream 1005, and issues a coded video bit stream 1006.

The stream header changing means 401, according to an instruction from the control means 900, sets the FRV in the sequence header (SH) of the coded video bit stream 1006 to a value corresponding to 24 Hz, and issues a coded video bit stream 1007.

The coded video bit stream 1007 is issued outside through the output means 104.

A moving image 1008 is a moving image displayed by decoding the coded video bit stream 1007. That is, the first, 16th, and subsequent frames of the moving image 201 are displayed sequentially. As a result, the display time of moving image 1008 is equal to the display time of the moving image 201.

In this embodiment, since only I frames are transmitted, if the first I′ (01) cannot be received due to some trouble, decoding can be started from the next I′ (01). Therefore, this embodiment is particularly effective when curtailing the coded video bit stream when P frames and B frames continue long after the I frame before bit rate curtailment.

(Embodiment 5)

A coded video bit stream processing apparatus in embodiment 5 of the invention is explained.

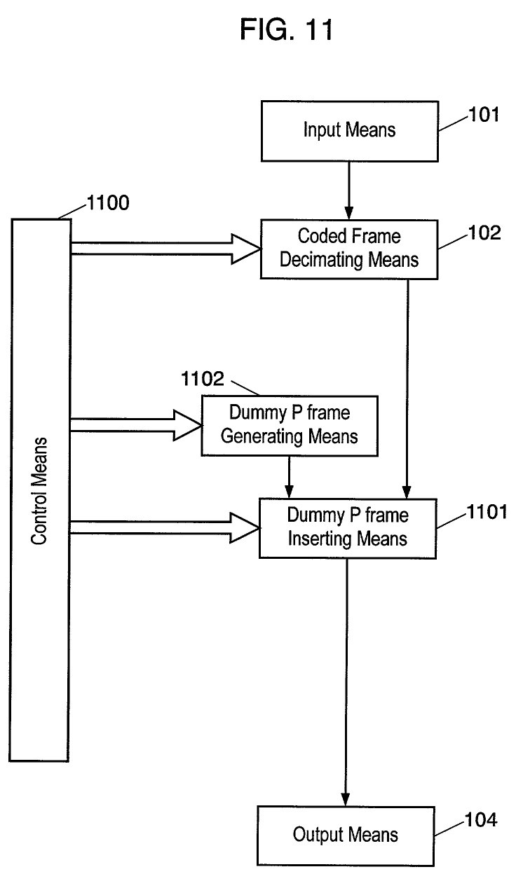

FIG. 11 is a block diagram of coded video bit stream processing apparatus in embodiment 5 of the invention. In this embodiment, the frame header changing means 103 shown in FIG. 1 is replaced by dummy P frame inserting means 1101, and dummy P frame generating means 1102 is further provided. In FIG. 11, same elements as explained in FIG. 1 are identified with same reference numerals.

The dummy P frame generating means 1102 generates a dummy P frame coded by using forward inter-frame motion compensation in which all motion vectors are vectors from the forward reference frame, and all DCT coefficients are 0. That is, the dummy P frame possesses only the beginning macro block information of the picture header, slice header, and slice. The motion vector of the beginning macro block of the slice is forward vector only, and both horizontal and vertical vectors are both 0. All DCT coefficients are also 0. The subsequent macro blocks are skipped macro blocks.

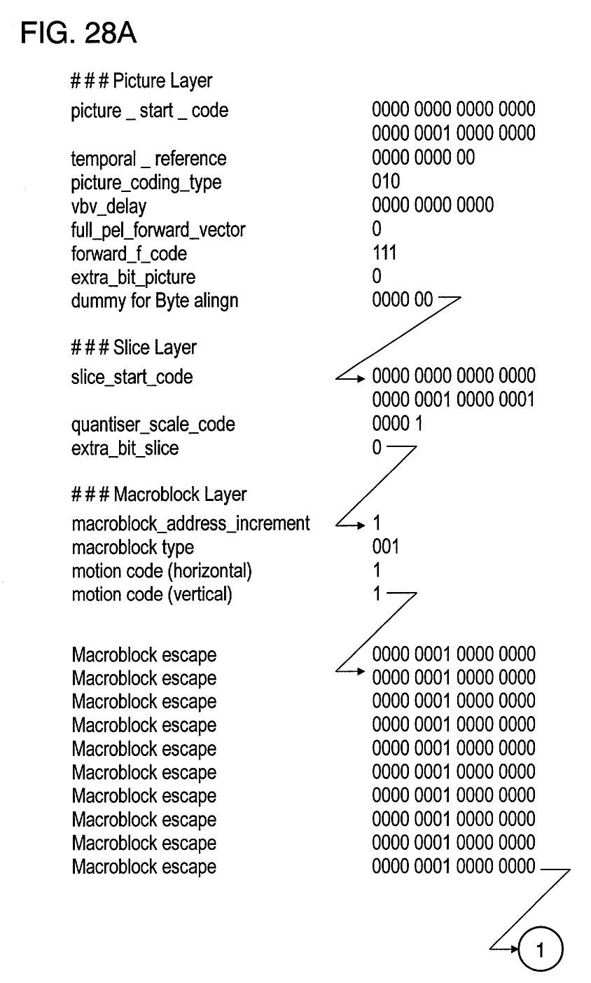

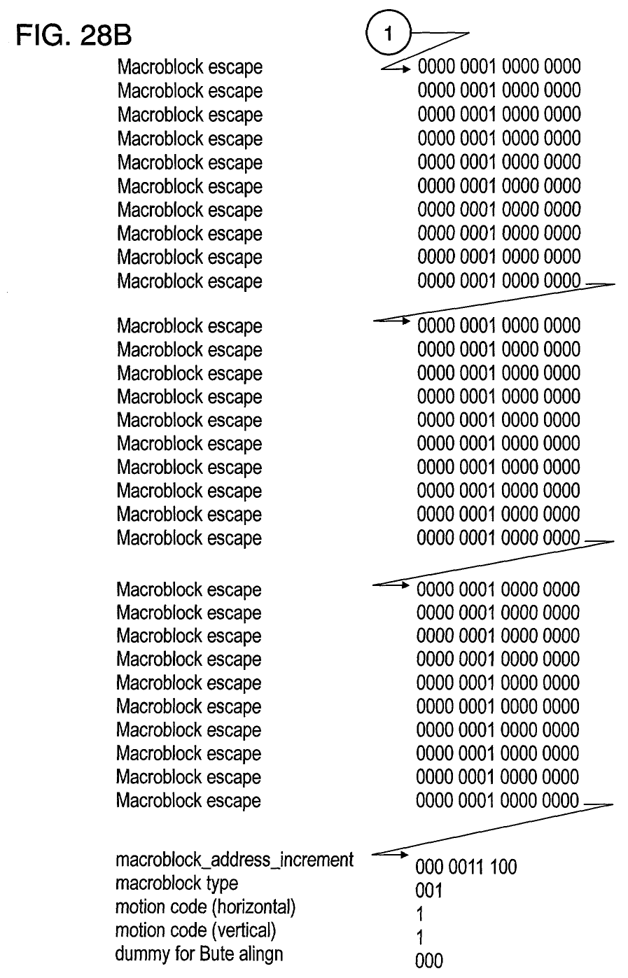

An example of dummy P frame is shown in FIGS. 28A, 28B. The dummy P frame is composed only of the picture header, slice header, and counter of skipped macro block, and is expressed by a fewer number of bits than in the original code. Substantially, the quantity of data can be ignored as compared with the quantity of data of the entire coded video bit stream.

The dummy P frame inserting means 1101 inserts a dummy P frame, instead of the deleted coded frame, in the coded video bit stream issued from the coded frame decimating means 102 according to an instruction from control means 1100.

Output means 104 issues the coded video bit stream issued from the dummy P frame inserting means 1101 to outside.

The control means 1100 controls the coded frame decimating means 102 and dummy P frame inserting means 1101 so that the display time of the moving image decoded from the coded video bit stream issued from the output means 104 may be nearly equal to the display time of the moving image decoded from the coded video bit stream entered from the input means 101. At this time, the control means 1100 controls them so that the coded video bit stream issued from the output means 104 may satisfy the standard of MPEG2.

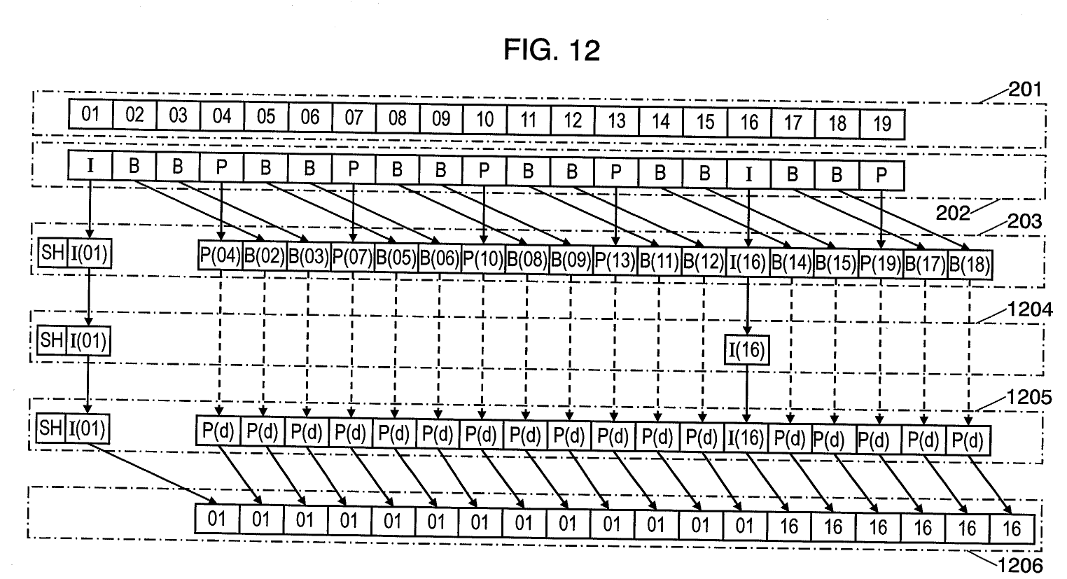

FIG. 12 is an operation timing chart showing a first operation example of coded video bit stream processing apparatus in embodiment 5. In FIG. 12, same elements as in the foregoing operation examples are identified with same reference numerals.

The coded frame decimating means 102 deletes all P frames and B frames from the coded video bit stream 203 according to an instruction from the control means 1100, and issues a coded video bit stream 1204.

The dummy P frame inserting means 1101, according to an instruction from the control means 1100, inserts a dummy P frame instead of the coded frame deleted by the coded frame decimating means 102, in the coded video bit stream 1204, and issues a coded video bit stream 1205. In the diagram, P (d) indicates a dummy P frame.

The coded video bit stream 1205 is issued outside through the output means 104.

A moving image 1206 is a moving image displayed by decoding the coded video bit stream 1205.

As mentioned above, when displaying by decoding the dummy P frame, the image decoding the coded frame to be referred to in the forward direction is displayed.

The coded video bit stream 1205 satisfies the MPEG2 standard, and the decoded display time is equal to the display time of the moving image 201.

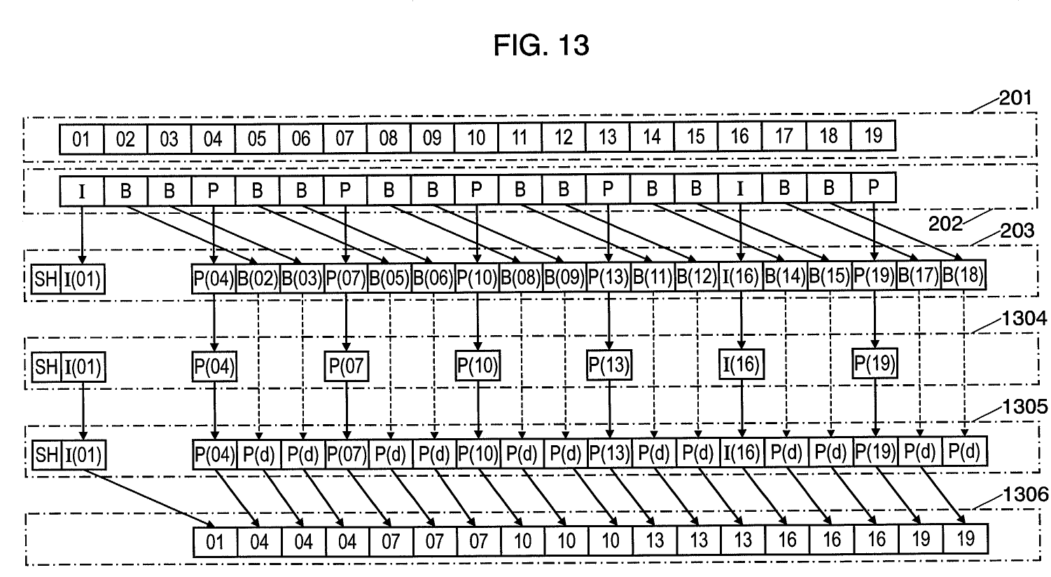

FIG. 13 is an operation timing chart showing a second operation example of coded video bit stream processing apparatus in embodiment 5. In FIG. 13, same elements as in the foregoing operation examples are identified with same reference numerals.

The coded frame decimating means 102, herein deletes all B frames from the coded video bit stream 203, and issues a coded video bit stream 1304.

The dummy P frame inserting means 1101 inserts a dummy P frame instead of the P frame deleted by the coded frame decimating means 102, in the coded video bit stream 1304, and issues a coded video bit stream 1305.

The coded video bit stream 1305 is issued outside through the output means 104.

A moving image 1306 is a moving image displayed by decoding the coded video bit stream 1305.

As mentioned above, when displaying by decoding the dummy P frame, the image decoding the coded frame to be referred to in the forward direction is displayed.

The coded video bit stream 1305 satisfies the MPEG2 standard, and the decoded display time is equal to the display time of the moving image 201.

Thus, the display time is equalized by deleting part of the coded frame from the entered coded video bit stream to curtail the bit rate, and inserting the dummy P frame of substantially zero data quantity instead of the deleted coded frame. That is, since B frame is not included in the coded video bit stream 1305, the structure of the decoding processing unit can be simplified.

Concerning embodiment 5, further, performance improving methods are explained.

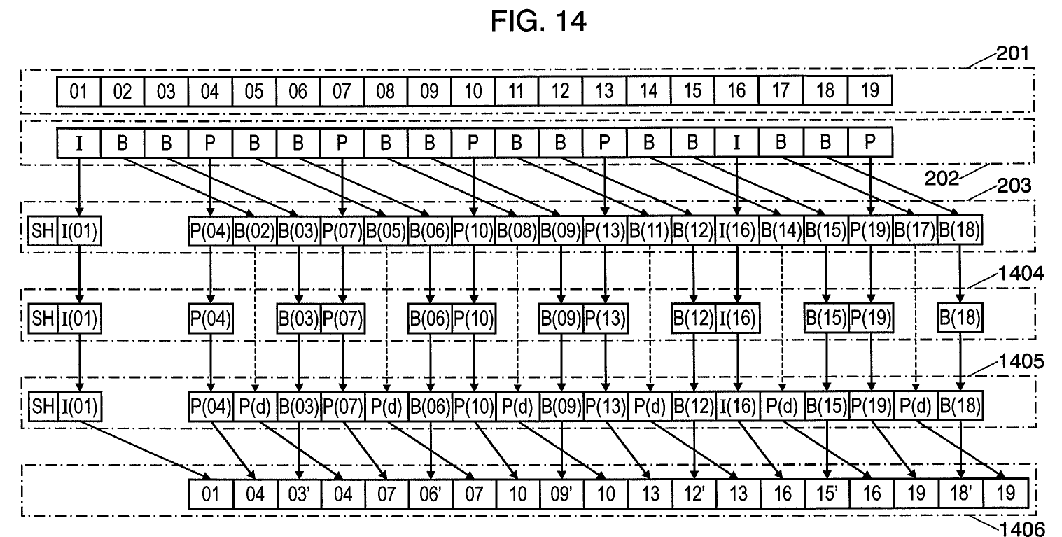

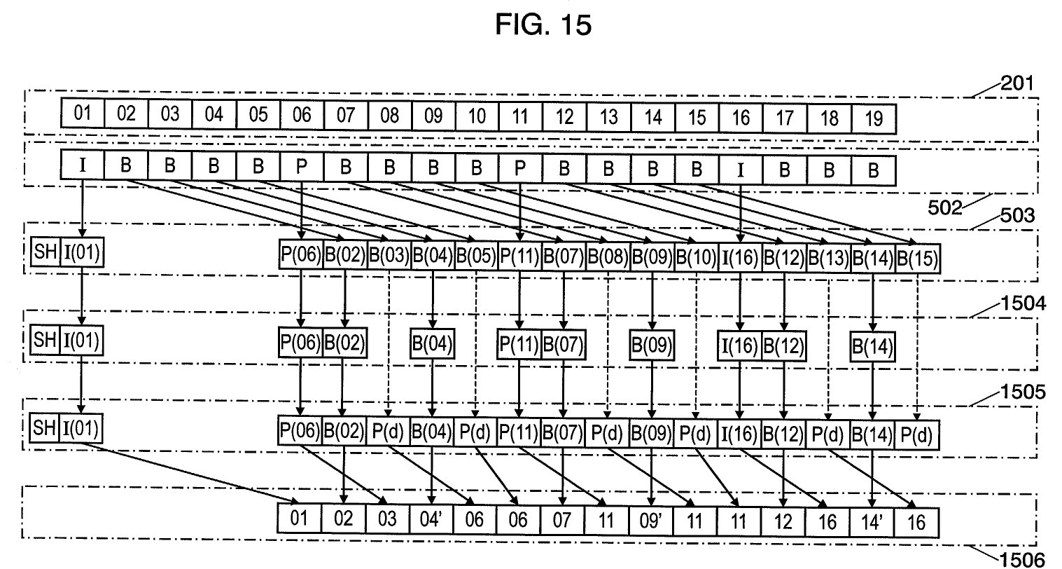

Prior to description of the performance improving methods, points for improving the performance are explained by referring to FIG. 14 and FIG. 15.

FIG. 14 is an operation timing chart showing a third operation example of coded video bit stream processing apparatus in embodiment 5. In FIG. 14, same elements as in the foregoing operation examples are identified with same reference numerals.

The coded frame decimating means 102 issues a coded video bit stream 1404 by deleting the first B frame of the B frames consecutive from the coded video bit stream 203. For example, B (02) is deleted from the continuous portion of B (02) and B (03) in the coded video bit stream 203.

The dummy P frame inserting means 1101 inserts a dummy P frame instead of the B frame deleted by the coded frame decimating means 102, in the coded video bit stream 1404, and issues a coded video bit stream 1405.

The coded video bit stream 1405 is issued outside through the output means 104.

A moving image 1406 is a moving image displayed by decoding the coded video bit stream 1405.

The decoding processing unit, when P (04) is entered, issues a decoded image of the previously entered I (01). Next, when P (d) is entered, a decoded image of P (04) is issued. When B (03) is entered, it is immediately decoded, and a decoded image of B (03) is issued. In decoding of B (03), the reference frames are P (04) and P (d) which immediately follows P (04). Since P (d) is same as P (04), B (03) is decoded with the forward reference frame as P (04) and backward reference frame also as P (04). The appendix (′) in the moving image 1406 shows that this frame is decoded by a different reference frame than the reference frame at the time of coding.

FIG. 15 is an operation timing chart showing a fourth operation example of coded video bit stream processing apparatus in embodiment 5. In FIG. 15, same elements as in the foregoing operation examples are identified with same reference numerals.

The coded frame decimating means 102 issues a coded video bit stream 1504 by deleting the second and fourth B frames of the B frames consecutive from the coded video bit stream 203. For example, B (03) and B (05) of consecutive B frames B (02), B (03), B (04), B (05) are deleted in the coded video bit stream 503.

The dummy P frame inserting means 1101 inserts a dummy P frame instead of the deleted B frame in the coded video bit stream 1504, and issues a coded video bit stream 1505.

The coded video bit stream 1505 is issued outside through the output means 104.

A moving image 1506 is a moving image displayed by decoding the coded video bit stream 1505.

The decoding processing unit, when P (06) is entered, issues a decoded image of the previously entered I (01). Next, when B (02) is entered, it is decoded and displayed with the forward reference frame as I (01) and backward reference frame as P (06). Then, when P (d) is entered, a decoded image of P (04) is issued. When B (04) is entered, it is immediately decoded, and a decoded image of B (04) is issued. In decoding of B (04), the reference frames are P (06) and P (d) which is immediately before B (04). Since P (d) is substantially equal to P (06), B (04) is decoded with the forward reference frame as P (06) and backward reference frame also as P (06). The appendix (′) in the moving image 1406 shows that this frame is decoded by a different reference frame than the reference frame at the time of coding.

Incidentally, in decoding of B (03) of coded video bit stream 1405 in FIG. 14, substantially, it is decoded by referring to P (04) in forward direction and backward direction. Actually, however, B (03) is coded with the forward reference frame as I (01) and backward reference frame also as P (04). Therefore, at the timing of decoding, the initial reference relation is broken. Also, in decoding of B (04) of coded video bit stream 1505 in FIG. 15, substantially, it is decoded by referring to P (06) in forward direction and backward direction. Actually, however, B (04) is coded with the forward reference frame as I (01) and backward reference frame also as P (06). Therefore, at the timing of decoding, the initial reference relation is broken. In this way, the reference frames are different in coding and decoding, but the image quality deterioration is slight in the case of a moving image of a relatively small motion, and it is sufficiently practicable. It is, however, preferred to refer to the same frame when coding and decoding.

A method for referring to the same frame when coding and decoding is explained below.

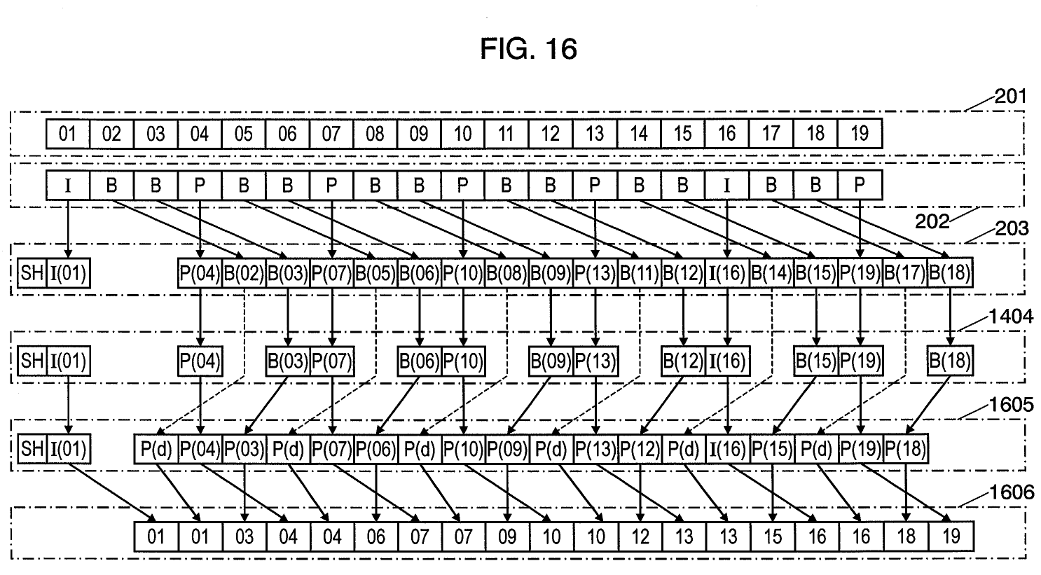

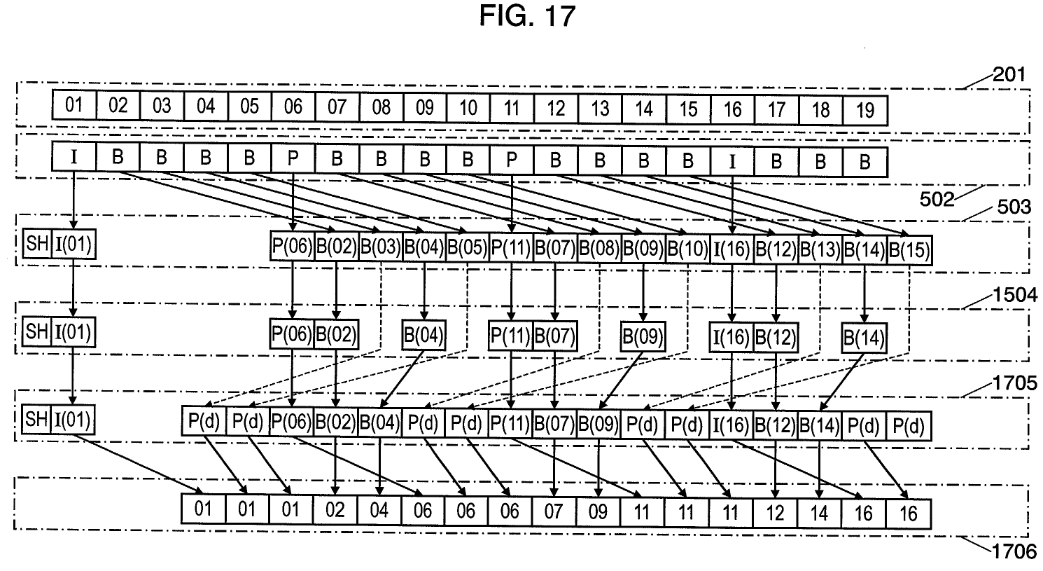

FIG. 16 is an operation timing chart showing a fifth operation example of coded video bit stream processing apparatus in embodiment 5. In FIG. 16, same elements as in the foregoing operation examples are identified with same reference numerals. The operation is same as in the example in FIG. 14 until the coded video bit stream 1404 is created by the coded frame decimating means 102.

In the operation example in FIG. 16, the dummy P frame inserting means 1101 inserts a dummy P frame instead of the deleted B frame, immediately before the I frame or P frame the deleted B frame has been referring to in the backward direction. For example, instead of the B (02) deleted in the process of creation of coded video bit stream 1404, a dummy P frame is inserted immediately before P (04) this B (02) has been referring to backward. Instead of the deleted B (05), a dummy P frame is inserted immediately before P (07) this B (05) has been referring to backward. Thus, a coded video bit stream 1605 is created.

A moving image 1606 is a moving image displayed by decoding the coded video bit stream 1605.

In the operation example in FIG. 14, the reference frame in decoding of B (03) is different from the reference frame in coding, but they are matched in FIG. 16. That is, as the reference frames of B (03) in decoding of coded video bit stream 1605, P (04) immediately before B (03) is the backward reference frame, and P (d) immediately before P (04) is the forward reference frame. This immediately preceding P (d) refers to I (01), and is substantially equal to I (01), and hence coincides with the reference frame in coding of B (03).

FIG. 17 is an operation timing chart showing a sixth operation example of coded video bit stream processing apparatus in embodiment 5. In FIG. 17, same elements as in the foregoing operation examples are identified with same reference numerals. The operation is same as in the example in FIG. 15 until the coded video bit stream 1504 is created by the coded frame decimating means 102.

In the operation example in FIG. 17, same as in the case of FIG. 16, the dummy P frame inserting means 1101 inserts a dummy P frame instead of the deleted B frame, immediately before the I frame or P frame the deleted B frame has been referring to in the backward direction. For example, instead of the deleted B (03), a dummy P frame is inserted immediately before P (06) this B (03) has been referring to backward. Instead of the deleted B (05), a dummy P frame is inserted immediately before P (06) this B (05) has been referring to backward. Thus, a coded video bit stream 1705 is created.

A moving image 1706 is a moving image displayed by decoding the coded video bit stream 1705.

In the operation example in FIG. 15, the reference frame in decoding of B (04) is different from the reference frame in coding, but they are matched in FIG. 17. That is, as the reference frames of B (04) in decoding of coded video bit stream 1705, P (06) is the backward reference frame, and P (d) immediately before P (06) is the forward reference frame. This P (d) immediately before P (06) refers to the second P (d) before P (06). The second P (d) before P (06) refers to I (01). Accordingly, P (d) immediately before P (06) the B (04) refers to forward when decoding is substantially equal to I (01). Therefore reference frames in coding and decoding of B (04) are matched.

Other method for referring to the same frame when coding and decoding is explained below.

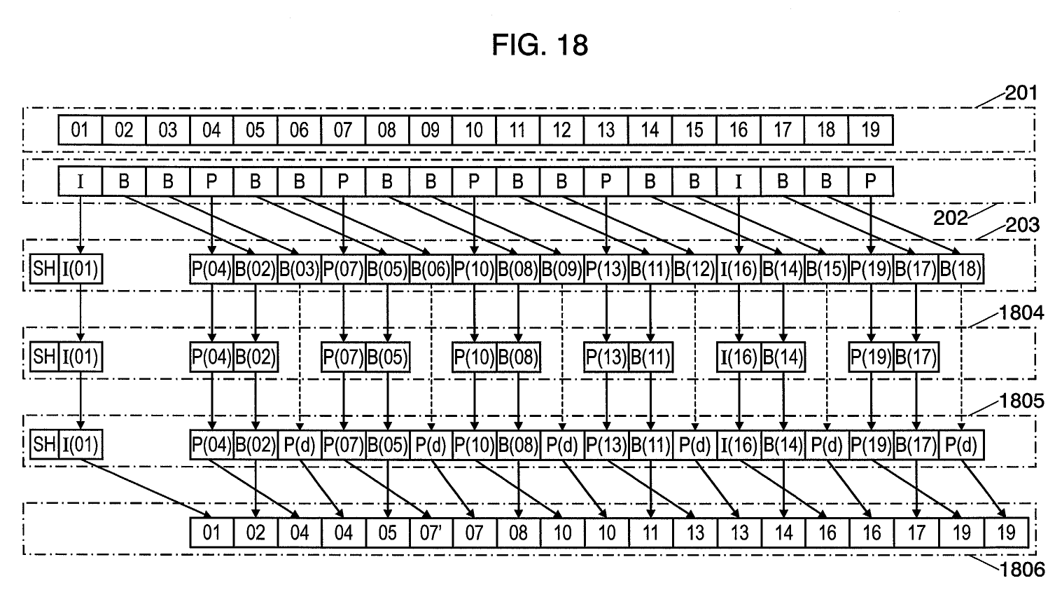

FIG. 18 is an operation timing chart showing a seventh operation example of coded video bit stream processing apparatus in embodiment 5. In FIG. 18, same elements as in the foregoing operation examples are identified with same reference numerals.

In the operation example in FIG. 18, the coded frame decimating means 102 deletes from the rear B frames of consecutive B frames in the coded video bit stream 203. That is, the coded frame decimating means 102 issues a coded video bit stream 1804 by deleting B (03), B (06), B (09) and others of rear B frames of consecutive B frames of the coded video bit stream 203.

The dummy P frame inserting means 1101 inserts a dummy P frame at the position once occupied by the deleted B frames in the coded video bit stream 1804, and issues a coded video bit stream 1805.

A moving image 1806 is a moving image displayed by decoding the coded video bit stream 1805.

In the operation example in FIG. 14, the reference frames in decoding and coding of the remaining B frames are different, but they are matched in FIG. 18.

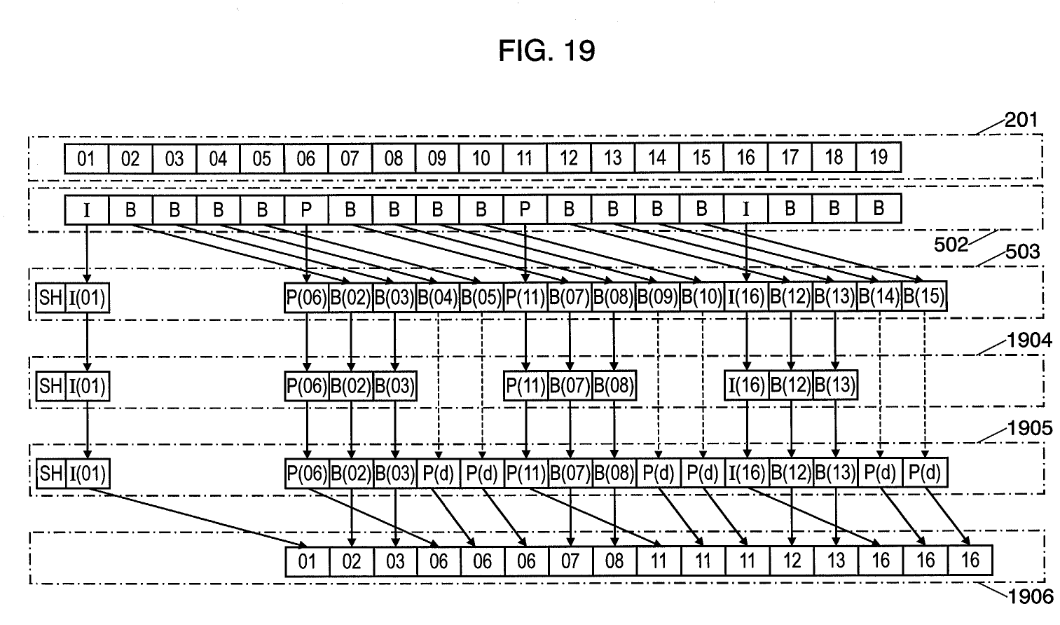

FIG. 19 is an operation timing chart showing an eighth operation example of coded video bit stream processing apparatus in embodiment 5. In FIG. 19, same elements as in the foregoing operation examples are identified with same reference numerals.

In the operation example in FIG. 19, the coded frame decimating means 102 deletes a plurality from the rear B frames of consecutive B frames in the coded video bit stream 203. That is, the coded frame decimating means 102 issues a coded video bit stream 1904 by deleting B (05), B (04), B (10), B (09) and others of rear B frames of consecutive B frames of the coded video bit stream 503.

The dummy P frame inserting means 1101 inserts a dummy P frame at the position once occupied by the deleted B frames in the coded video bit stream 1904, and issues a coded video bit stream 1905.

A moving image 1906 is a moving image displayed by decoding the coded video bit stream 1905.

In the operation example in FIG. 15, the reference frames in decoding and coding of the remaining B frames are different, but they are matched in FIG. 19.

In the operation examples shown in FIG. 16 and FIG. 17, a buffer (not shown) is provided in order to insert the dummy P frame immediately before the backward reference frame existing ahead. Such buffer is not required in the operation examples shown in FIG. 18 and FIG. 19.

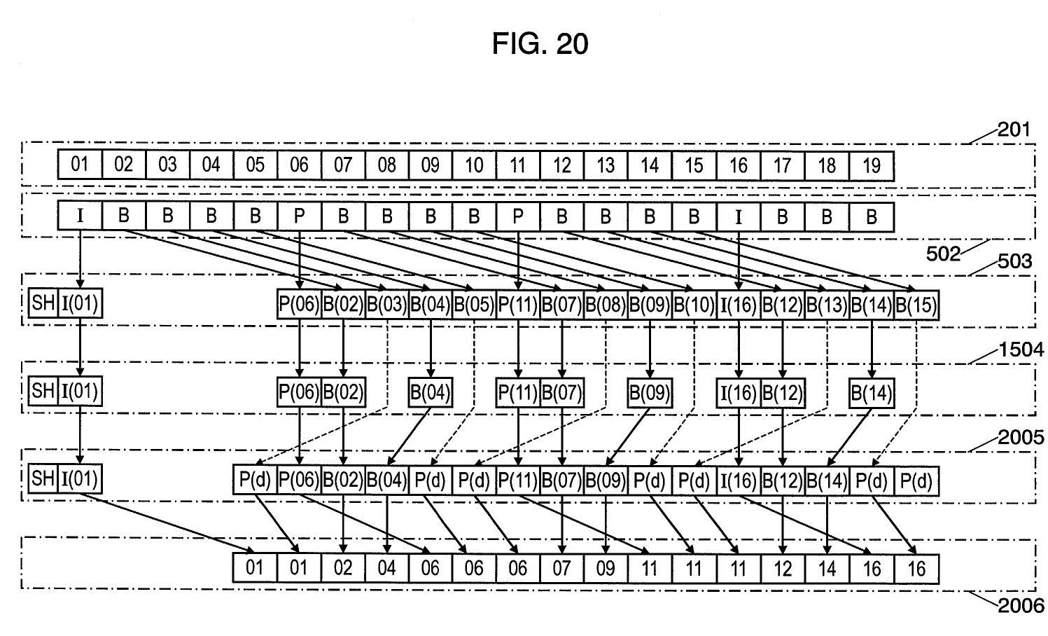

It is possible to combine the method shown in FIG. 16 and FIG. 17, and the method shown in FIG. 18 and FIG. 19. In this case, (1) when B frames are deleted consecutively from the rear one of the consecutive B frames, the dummy P frame is inserted in the deleted position, and (2) when non-consecutive B frames are deleted from the rear one, the dummy P frame is inserted immediately before the I frame or P frame this B frame has been referring to backward. An example of case (2) is shown in FIG. 20.

As clear from FIG. 20, when decoding a coded video bit stream 2005, the reference frame of each B frame coincides with the reference frame when coding the B frame.

Thus, since no B frame is left over behind dummy P frame, the relation of reference frames in coding and decoding can be matched.

In the embodiments explained so far, the quantity of data is curtailed by deleting part of the coded frame from the entered coded video bit stream, and it is intended to select

change of frame header,

change of stream header, or

insertion of dummy P frame,

so that the display time may be nearly same as that of the entered coded video bit stream. The three choices after deleting the coded frame can be arbitrarily combined. A combined case of change of frame header and change of stream header is same as explained in embodiment 3 by referring to FIG. 7 and FIG. 8. Examples of other combinations about these three choices are explained below.

(Embodiment 6)

A coded video bit stream processing apparatus in embodiment 6 of the invention is explained.

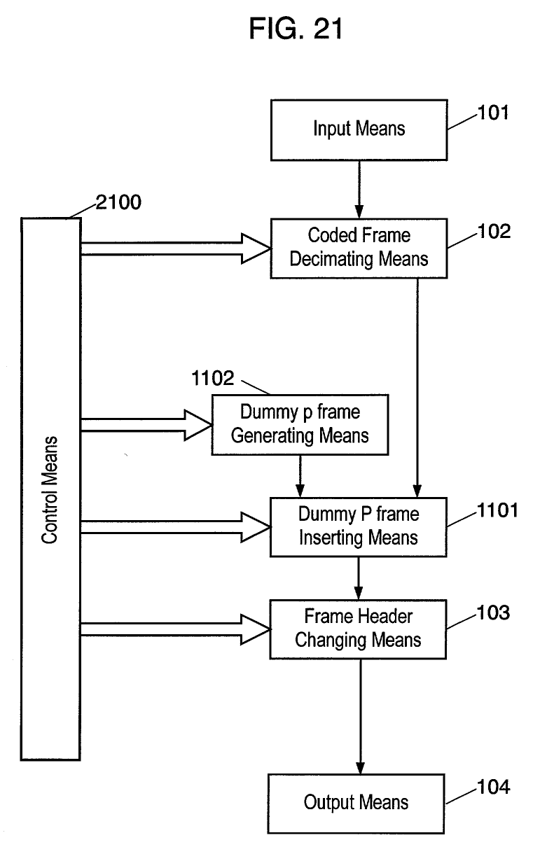

FIG. 21 is a block diagram of coded video bit stream processing apparatus in embodiment 6 of the invention. In this embodiment, frame header changing means 103 is provided between the dummy P frame inserting means 1101 and output means 104 in FIG. 11.

In FIG. 21, same elements as explained before are identified with same reference numerals.

The frame header changing means 103 rewrites a flag indicating the frequency of repeated reproductions in the picture header of part or whole of coded frames in the coded video bit stream issued from the dummy P frame inserting means.

The control means 2100 controls the coded frame decimating means 102, dummy P frame inserting means 1101, and the frame header changing means 103 so that the display time of the moving image decoded from the coded video bit stream issued from the output means 104 may be nearly equal to the display time of the moving image decoded from the coded video bit stream entered from the input means 101. At this time, the control means 2100 controls them so that the coded video bit stream issued from the output means 104 may satisfy the standard of MPEG2.

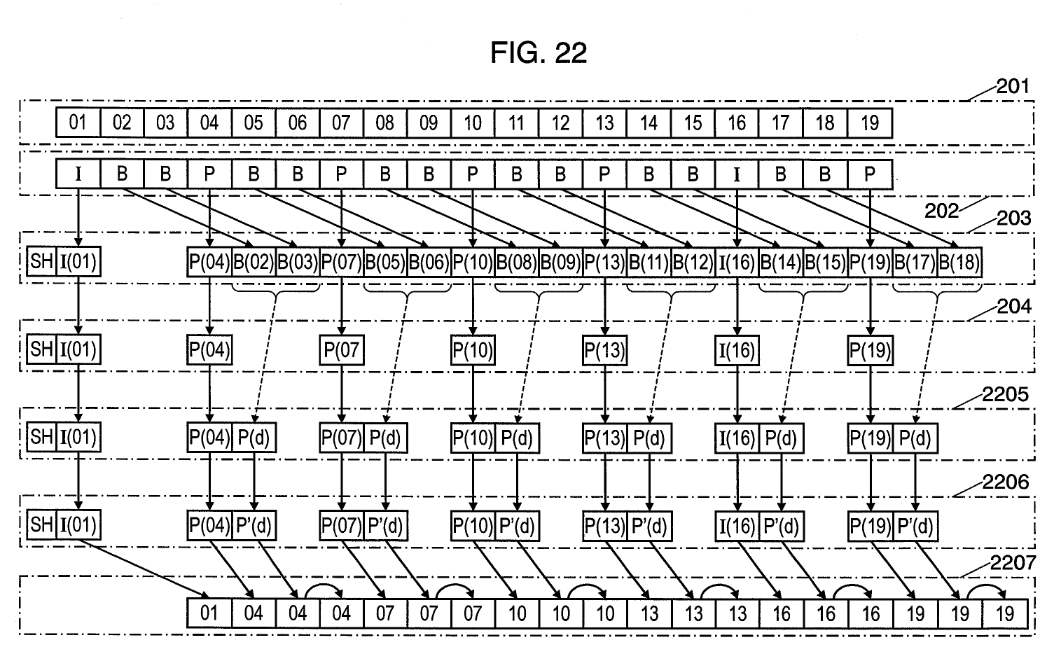

FIG. 22 is an operation timing chart showing a first operation example of coded video bit stream processing apparatus in embodiment 6. In FIG. 22, same elements as in the foregoing operation examples are identified with same reference numerals.

The dummy P frame inserting means 1101 inserts one dummy P frame instead of the consecutive B frames deleted by the coded frame decimating means 102, in the coded video bit stream 204 from which B frames have been deleted, and issues a coded video bit stream 2205.

The frame header changing means 103 changes the picture header of the dummy P frame of the coded video bit stream 2205, and issues a coded video bit stream 2206. Specifically, the value of RFF is set to 1, and the value of TFF is set to 0. As a result, when the dummy P frame is decoded, the decoded image is displayed twice.

The coded video bit stream 2206 is issued outside through the output means 104.

A moving image 2207 is a moving image displayed by decoding the coded video bit stream 2206.

In this operation example, after inserting the dummy P frame, the picture header of this dummy P frame is changed, but, alternatively, the dummy P frame generating means 1102 may be designed to generate the dummy P frame having the value of RFF set at 1 and the value of TFF set at 0. In this case, the frame header changing means 103 may be omitted.

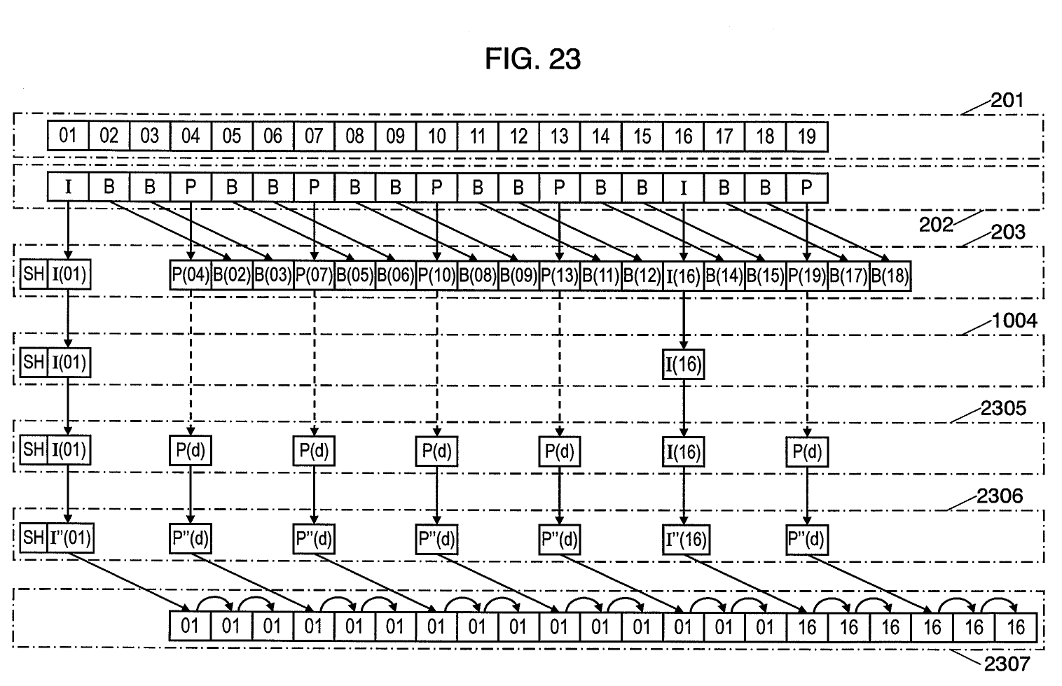

FIG. 23 is an operation timing chart showing a second operation example of coded video bit stream processing apparatus in embodiment 6. In FIG. 23, same elements as in the foregoing operation examples are identified with same reference numerals.

The dummy P frame inserting means 1101 inserts a dummy P frame at the position of the P frame deleted by the coded frame decimating means 102, in the coded video bit stream 1004 from which the P frames and B frames are deleted, and issues a coded video bit stream 2305.

The frame header changing means 103 changes the picture header of the I frame and dummy P frame of the coded video bit stream 2305, and issues a coded video bit stream 2306. Specifically, the value of RFF is set to 1, and the value of TFF is set to 1. As a result, when each coded frame is decoded, the decoded image is displayed three times each.

The coded video bit stream 2306 is issued outside through the output means 104.

A moving image 2307 is a moving image displayed by decoding the coded video bit stream 2206.

In embodiment 6, by combining with change of picture header, the number of dummy P frames to be inserted instead of the deleted coded frames is decreased. Of course, if the change of picture header does not satisfy the MPEG2 standard, the number of dummy P frames to be inserted is adjusted.

(Embodiment 7)

A coded video bit stream processing apparatus in embodiment 7 of the invention is explained.

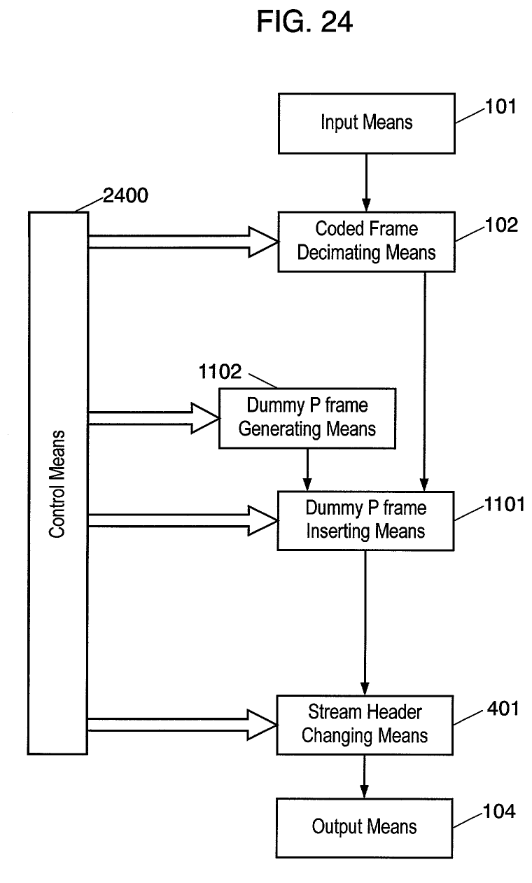

FIG. 24 is a block diagram of coded video bit stream processing apparatus in embodiment 7 of the invention. In this embodiment, the frame header changing means 103 shown in FIG. 21 is replaced with stream header changing means 401.

In FIG. 24, same elements as explained before are identified with same reference numerals.

The stream header changing means 401 rewrites a flag indicating the frame rate in the sequence header of the coded video bit stream in which the dummy P frame is inserted according to an instruction from control means 2400.

The output means 104, herein, issues the coded video bit stream obtained by the stream header changing means 401 to outside.

The control means 2400 controls the coded frame decimating means 102, dummy P frame inserting means 1101, and stream header changing means 401 so that the display time of the moving image decoded from the coded video bit stream issued from the output means 104 may be nearly equal to the display time of the moving image decoded from the coded video bit stream entered from the input means 101.

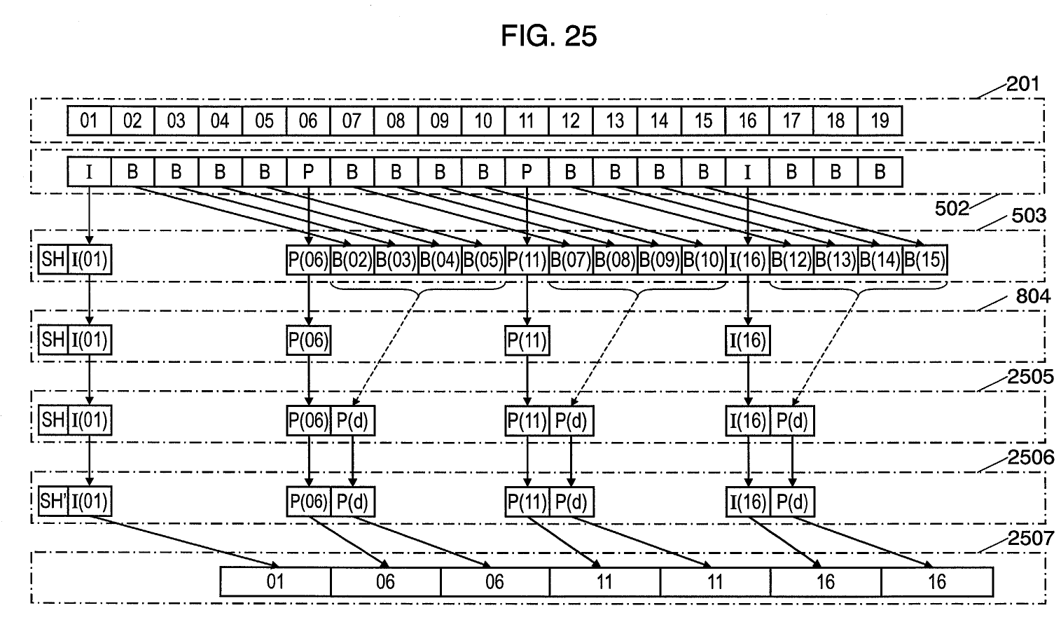

FIG. 25 is an operation timing chart showing an operation example of coded video bit stream processing apparatus in embodiment 7. In FIG. 25, same elements as in the foregoing operation examples are identified with same reference numerals.

The dummy P frame inserting means 1101 inserts one dummy P frame instead of a set of consecutive B frames deleted by the coded frame decimating means 102, and issues a coded video bit stream 2505.

The stream header changing means 401 changes the FRV in the sequence header (SH) of the coded video bit stream 2505 to a value corresponding to 24 Hz according to an instruction from the control means 700,and issues a coded video bit stream 2506.

The coded video bit stream 2506 is issued outside through the output means 104.

A moving image 2507 is a moving image displayed by decoding the coded video bit stream 2506.

In embodiment 7, by combining with change of sequence header, the number of dummy P frames to be inserted instead of the deleted coded frames is decreased. Of course, if the change of sequence header does not satisfy the MPEG2 standard, the number of dummy P frames to be inserted is adjusted.

(Embodiment 8)

A coded video bit stream processing apparatus in embodiment 8 of the invention is explained.

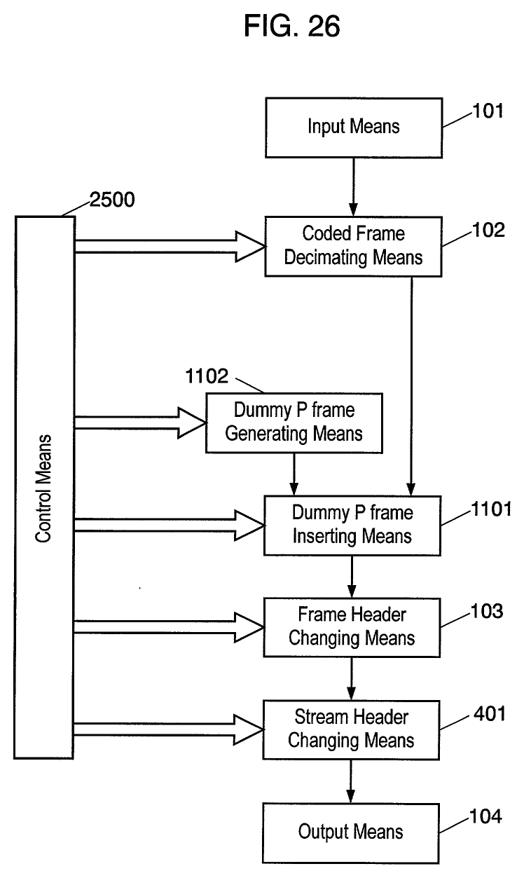

FIG. 26 is a block diagram of coded video bit stream processing apparatus in embodiment 8 of the invention. In this embodiment, stream header changing means 401 is provided between the frame header changing means 103 and output means 104 shown in FIG. 21.

In FIG. 26, same elements as explained in FIG. 21 are identified with same reference numerals.

The stream header changing means 401 rewrites a flag indicating the frame rate in the sequence header of the coded video bit stream issued from the frame header changing means.

The output means 104 issues the output of the stream header changing means 401 to outside.

The control means 2600 controls the codedframe decimating means 102, dummy P frame inserting means 1101, frame header changing means 103, and stream header changing means 401 so that the display time of the moving image decoded from the coded video bit stream issued from the output means 104 may be nearly equal to the display time of the moving image decoded from the coded video bit stream entered from the input means 101.

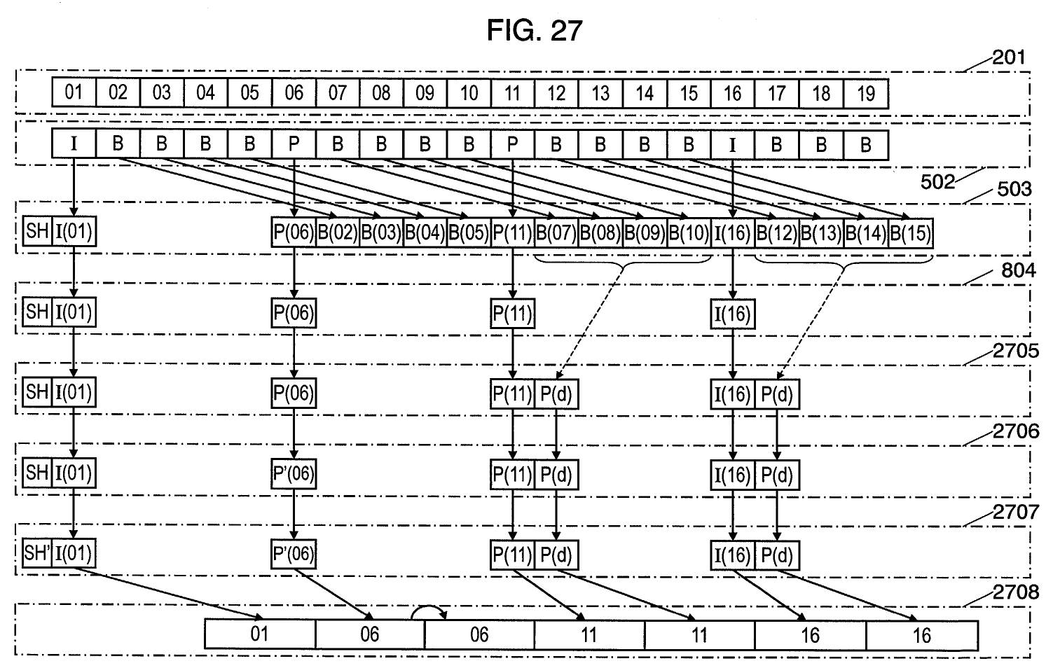

FIG. 27 is an operation timing chart showing an operation example of coded video bit stream processing apparatus in embodiment 8. In FIG. 27, same elements as in the foregoing operation examples are identified with same reference numerals.

The dummy P frame inserting means 1101 inserts one dummy P frame instead of the consecutive B frames deleted by the coded frame decimating means 102, in the coded video bit stream 804 from which the B frames are deleted, and issues a coded video bit stream 2705.

The frame header changing means 103 changes the picture header of part of the coded frames of the coded video bit stream 2705, and issues a coded video bit stream 2706. Specifically, the value of RFF of P (06) is set to 1, and the value of TFF is set to 0. As a result, when the dummy P frame is decoded, the decoded image is displayed twice.

The stream header changing means 401 changes the FRV in the sequence header (SH) of the coded video bit stream 2706 to a value corresponding to 24 Hz according to an instruction from the control means 2700, and issues a coded video bit stream 2707.

The coded video bit stream 2707 is issued outside through the output means 104.

A moving image 2708 is a moving image displayed by decoding the coded video bit stream 2707.

In embodiment 8, by combining with change of picture header and sequence header, the number of dummy P frames to be inserted instead of the deleted coded frames is decreased. Of course, if the change of picture header and sequence header does not satisfy the MPEG2 standard, the number of dummy P frames to be inserted is adjusted.

In the foregoing embodiments, the I frames are not deleted, but they may be also deleted. In some of the embodiments, the P frame are not deleted, but they may be also deleted. In such a case, if P frames or B frames are left over, it is preferred not to delete the coded frame to which the pertinent coded frame is referring currently. When deleting the I frames or P frames, it is preferred to delete the P frames and B frames being referred to at the same time.

In the foregoing embodiments, principal matters of the invention are explained, but various flags in the headers may be added or changed as required. For example, if necessary, bit_rate_value or _buffer_size_value (VBV) in the stream header may be changed.

In the embodiments, the invention is applied to the coded video bit stream of MPEG2, but it may be also applied in coded video bit streams of various coded video systems such as MPEG1 or MPEG4.

Concerning each means of the embodiments, part or whole of the functions may be realized by a program running on a personal computer. The program may be stored in recording medium that can be read by a personal computer such as CD-ROM or floppy disk, or may be distributed through the Internet.

In recent personal computers, the software for browsing the MPEG moving image is installed. Therefore, by installing the program of the invention in a personal computer, moving image contents at a remote place may be viewed at a bit rate corresponding to the state of the transmission route by way of the Internet. Of course, moving image contents accumulated in the home server in each household may be viewed at a desired terminal through the local area network.

As described herein, according to the processing method and apparatus of coded video bit stream of the invention, while satisfying the standard regulations of the desired coded video bit streams, the bit rate can be curtailed without decoding the coded data.

The coded video bit stream curtailed in the bit rate by the method and apparatus of the invention can be decoded and displayed by a decoder of a general standard specification. Its display time is equal to the display time of the coded video bit stream before bit rate curtailment. That is, without changing the display time depending on the state of transmission route, it is possible to transmit by curtailing the bit rate. Without requiring any particular process at the receiving side, the moving image accumulated at the transmitting side can be viewed.

Also according to the processing method and apparatus of coded video bit stream of the invention, the coded video bit stream containing B frames may be transformed into a bit stream not containing B frames. The simple profile of MPEG4 is suited to architecture of service using mobile terminal. In the simple profile of MPEG4, B frames are not specified. According to the invention, without decoding, a bit stream of core profile or main profile of MPEG4 containing B frames may be transformed into a bit stream specified in the simple profile. That is, moving image materials accumulated in various forms may be effectively re-utilized.

The invention may be applied in various forms. For example, in the foregoing embodiments, the coded frames deleted by the coded frame decimating means are discarded, but they may be collected and transmitted separately. That is, concerning the coded video bit stream curtailed in the bit rate, the information showing the data is created by what processes before bit rate curtailment, and the data of deleted coded frame are separately transmitted, so that the coded video bit stream before bit rate curtailment can be reproduced at the receiving side. For example, to a general destination, the coded video bit stream curtailed in the bit rate may be broadcast, and to a special destination, other information may be presented by other charged media.

What is claimed is:

1. A processing method of coded video bit stream comprising:
(a) a step of creating a second coded video bit stream by deleting a part of frames in a first coded video bit stream; and
at least one of (b) a step of rewriting a flag indicating a repeat display frequency in a frame header of the second coded video bit stream and (c) a step of rewriting a flag indicating a frame rate in a stream header of the second coded video bit stream.

2. The processing method of coded video bit stream of claim 1, further comprising:
a step of controlling step (a) and at least one of step (b) and step (c) so that display time of a moving image decoded from a coded video bit stream processed at the step of at least one of step (b) and step (c) may be nearly equal to display time of a moving image decoded from the first coded video bit stream.

3. A processing method of coded video bit stream comprising the steps of:
(a) creating a second coded video bit stream by deleting a part of frame in a first coded video bit stream; and
(b) inserting a dummy P frame of which all motion vectors are vectors from forward reference frame and all DCT coefficients are 0, in the second coded video bit stream.

4. The processing method of coded video bit stream of claim 3, further comprising:
a step of controlling step (a) and step (b) so that display time of a moving image decoded from a coded video bit stream processed at step (b) may be nearly equal to display time of a moving image decoded from the first coded video bit stream.

5. The processing method of coded video bit stream of claim 3, further comprising:
at least one of the steps of (c) rewriting a flag indicating a repeat reproduction frequency in a frame header of a coded video bit stream processed at step (b), and (d) rewriting a flag indicating a frame rate in a stream header of the coded video bit stream processed at step (b).

6. The processing method of coded video bit stream of claim 5, further comprising:
a step of controlling step (a), step (b), and at least one of step (c) and step (d) so that display time of a moving image decoded from a coded video bit stream processed at the step of at least one of step (c) and step (d) may be nearly equal to display time of a moving image decoded from the first coded video bit stream.

7. The processing method of coded video bit stream of any one of claims 3 to 6,
wherein step (b) is for inserting the dummy P frame into a specified position, and there is no B frame between the specified position and closest I frame or P frame behind the specified position.

8. The processing method of coded video bit stream of claim 7,
wherein step (a) is for deleting a B frame including at least the last frame of consecutive B frames in the first coded video bit stream, and step (b) is for inserting at least one of the dummy P frame in the position of the deleted B frame.

9. The processing method of coded video bit stream of claim 7,
wherein step (a) is for deleting at least part of B frames in the first coded video bit stream, and step (b) is for inserting the dummy P frame in the position before a coded frame the deleted B frames has been referring to backward.

10. The processing method of coded video bit stream of any one of claims 1 to 6,
wherein step (a) is for deleting both a P frame and a B frame referring to an I frame to be deleted when deleting the I frame in the first coded video bit stream, and deleting both a P frame and a B frame referring to a P frame to be deleted when deleting the P frame in the first coded video bit stream

11. The processing method of coded video bit stream of claim 7,
wherein step (a) is for deleting both a P frame and a B frame referring to an I frames to be deleted when deleting the I frames in the first coded video bit stream, and deleting both P frames and B frames referring to a P frame to be deleted when deleting the P frame in the first coded video bit stream.

12. The processing method of coded video bit stream of claim 8,
wherein step (a) is for deleting both a P frame and a B frame referring to an I frame to be deleted when deleting the I frame in the first coded video bit stream, and deleting both a P frames and a B frames referring to a P frame to be deleted when deleting the P frame in the first coded video bit stream.

13. The processing method of coded video bit stream of claim 9,
wherein step (a) is for deleting both a P frame and a B frame referring to an I frame to be deleted when deleting the I frame in the first coded video bit stream, and deleting both a P frames and a B frame referring to a P frame to be deleted when deleting the P frame in the first coded video bit stream.

14. The processing method of coded video bit stream of claim 10,
wherein step (a) is for copying an I frame at a close position in the forward direction of the deleted part of frames, in part of the position once occupied by the deleted part of frames.

15. The processing method of coded video bit stream of claim 11,
wherein step (a) is for copying an I frame at a close position in the forward direction of the deleted part of frames, in part of the position once occupied by the deleted part of frames.

16. The processing method of coded video bit stream of claim 12,
wherein step (a) is for copying an I frame at a close position in the forward direction of the deleted part of frames, in part of the position once occupied by the deleted part of frames.

17. The processing method of coded video bit stream of claim 13,
wherein step (a) is for copying an I frame at a close position in the forward direction of the deleted part of frames, in part of the position once occupied by the deleted part of frames.

18. The processing method of coded video bit stream of any one of claims 1 to 6,
wherein step (a) is for deleting the deleted part of frames is deleted at specific intervals.

19. A processing apparatus of coded video bit stream comprising:
first means for creating a second coded video bit stream by deleting a coded frame from a first coded video bit stream; and
at least one of second means for rewriting a flag indicating a repeat display frequency in the frame header of the second coded video bit stream, and third means for rewriting a flag indicating a frame rate in a stream header of the second coded video bit stream.

20. The processing apparatus of coded video bit stream of claim 19, further comprising:
means for controlling the first means and at least one of the second means and third means so that display time of a moving image decoded from a coded video bit stream processed by at least one of the second means and third means may be nearly equal to display time of a moving image decoded from the first coded video bit stream.

21. A processing apparatus of coded video bit stream comprising:
first means for creating a second coded video bit stream by deleting a coded frame from a first coded video bit stream; and
second means for inserting a dummy P frame of which all motion vectors are vectors from forward reference frame and all DCT coefficients are 0, in the second coded video bit stream.

22. The processing apparatus of coded video bit stream of claim 21, further comprising:
means for controlling the first means and the second means so that display time of a moving image decoded from a coded video bit stream processed by the second means may be nearly equal to display time of a moving image decoded from the first coded video bit stream.

23. The processing apparatus of coded video bit stream of claim 21, further comprising:
at least one of third means for rewriting a flag indicating a repeat reproduction frequency in the frame header of the coded video bit stream processed by the second means, and fourth means for rewriting a flag indicating a frame rate in a stream header of the coded video bit stream processed by the second means.

24. The processing apparatus of coded video bit stream of claim 23, further comprising:
means for controlling the first means, the second means, and at least one of the third means and the fourth means so that display time of a moving image decoded from a coded video bit stream processed by at least one of the third means and fourth means may be nearly equal to display time of a moving image decoded from the first coded video bit stream.

25. The processing apparatus of coded video bit stream of any one of claims 21 to 24,
wherein the second means is for inserting the dummy P frame into a specified position, and there is no B frame between the specified position and closest I frame or P frame behind the specified position.

26. The processing apparatus of coded video bit stream of claim 25,
wherein the first means is for deleting a B frame including at least the last frame of consecutive B frames in the first coded video bit stream, and the second means is for inserting at least one of the dummy P frame in the position of the deleted B frame .

27. The processing apparatus of coded video bit stream of claim 25,
wherein the first means is for deleting at least part of B frames in the first coded video bit stream, and the second means is for inserting the dummy P frame in a position before a coded frame the deleted B frames has been referring to backward.

28. The processing apparatus of coded video bit stream of any one of claims 19 to 24,
wherein the first means is for deleting both a P frame and a B frame referring to an I frame to be deleted when deleting the I frame in the first coded video bit stream, and deleting both a P frame and a B frame referring to a P frame to be deleted when deleting the P frame in the first coded video bit stream.

29. The processing apparatus of coded video bit stream of claim 25,
wherein the first means is for deleting both a P frame and a B frame referring to an I frame to be deleted when deleting the I frame in the first coded video bit stream, and deleting both a P frame and a B frame referring to the P frame to be deleted when deleting the P frame in the first coded video bit stream.

30. The processing apparatus of coded video bit stream of claim 26,
wherein the first means is for deleting both a P frame and a B frame referring to an I frame to be deleted when deleting the I frame in the first coded video bit stream, and deleting both a P frame and a B frame referring to a P frame to be deleted when deleting the P frame in the first coded video bit stream.

31. The processing apparatus of coded video bit stream of claim 27,
wherein the first means is for deleting both a P frame and a B frame referring to an I frame to be deleted when deleting the I frame in the first coded video bit stream, and deleting both a P frame and a B frame referring to a P frame to be deleted when deleting the P frames in the first coded video bit stream.

32. The processing apparatus of coded video bit stream of claim 28,
wherein the first means is for copying the I frame at a close position in the forward direction of the deleted part of frames, in part of the position once occupied by the deleted part of frames.

33. The processing apparatus of coded video bit stream of claim 29,
wherein the first means is for copying an I frame at a close position in the forward direction of the deleted part of frame, in part of the position once occupied by the deleted part of frame.

34. The processing apparatus of coded video bit stream of claim 30,
wherein the first means is for copying an I frame at a close position in the forward direction of the deleted part of frames, in part of the position once occupied by the deleted part of frames.

35. The processing apparatus of coded video bit stream of claim 31,
wherein the first means is for copying an I frame at a close position in the forward direction of the deleted part of frame, in part of the position once occupied by the deleted part of frame.

36. The processing apparatus of coded video bit stream of any one of claims 19 to 24,
wherein the first means is for deleting the deleted part of frames at specific intervals.

37. A recording medium storing the coded video bit stream processing program comprising:
(a) a program for creating a second coded video bit stream by deleting a part of frames in a first coded video bit stream; and
at least one of (b) a program for rewriting a flag indicating a repeat display frequency in a frame header of the second coded video bit stream and (c) a program for rewriting a flag indicating a frame rate in a stream header of the second coded video bit stream.

38. The recording medium storing the coded video bit stream processing program of claim 1, further comprising:
a program for controlling program (a) and at least one of program (b) and program (c) so that display time of a moving image decoded from a coded video bit stream processed by at least one of program (b) and program (c) may be nearly equal to display time of a moving image decoded from the first coded video bit stream.

39. A recording medium storing the coded video bit stream processing program comprising the programs for:
(a) creating a second coded video bit stream by deleting part of a frame in a first coded video bit stream; and
(b) inserting a dummy P frame of which all motion vectors are vectors from forward reference frame and all DCT coefficients are 0, in the second coded video bit stream.

40. The recording medium storing the coded video bit stream processing program of claim 39, further comprising:
a program for controlling program (a) and program (b) so that display time of a moving image decoded from a coded video bit stream processed by program (b) may be nearly equal to display time of a moving image decoded from the first coded video bit stream.

41. The recording medium storing the coded video bit stream processing program of claim 40, further comprising:
at least one of the programs for (c) rewriting a flag indicating a repeat reproduction frequency in a frame header of a coded video bit stream processed by program (b), and (d) rewriting a flag indicating a frame rate in a stream header of the coded video bit stream processed at program (b).

42. The recording medium storing the coded video bit stream processing program of claim 41, further comprising:
a program for controlling program (a), program (b), and at least one of program (c) and program (d) so that display time of a moving image decoded from a coded video bit stream processed by at least one of program (c) and program (d) may be nearly equal to display time of a moving image decoded from the first coded video bit stream.

43. The recording medium storing the coded video bit stream processing program of any one of claims 39 to 42,
wherein program (b) is for inserting the dummy P frame into a specified position, and there is no B frame between the specified position and closest I frame or P frame behind the specified position.

44. The recording medium storing the coded video bit stream processing program of claim 43,
wherein program (a) is for deleting a B frame including at least the last frame of consecutive B frames in the first coded video bit stream, and program (b) is for inserting at least one of the dummy P frame in the position of the deleted-B frame.

45. The recording medium storing the coded video bit stream processing program of claim 43,
wherein program (a) is for deleting at least part of B frame in the first coded video bit stream, and program (b) is for inserting the dummy P frame in the position before a coded frame the deleted B frames has been referring to backward.

46. The recording medium storing the coded video bit stream processing program of any one of claims 37 to 42,
wherein program (a) is for deleting both a P frame and a B frame referring to an I frame to be deleted when deleting the I frames in the first coded video bit stream, and deleting both a P frame and B frame referring to a P frame to be deleted when deleting the P frame in the first coded video bit stream.

47. The recording medium storing the coded video bit stream processing program of claim 43,
wherein program (a) is for deleting both a P frame and B frame referring to an I frame to be deleted when deleting the I frame in the first coded video bit stream, or deleting both a P frame and a B frame referring to the P frame to be deleted when deleting the P frame in the first coded video bit stream.

48. The recording medium storing the coded video bit stream processing program of claim 44,
wherein program (a) is for deleting both a P frame and a B frame referring to an I frame to be deleted when deleting the I frame in the first coded video bit stream, and deleting both a P frame and a B frame referring to a P frame to be deleted when deleting the P frame in the first coded video bit stream.

49. The recording medium storing the coded video bit stream processing program of claim 45,
wherein program (a) is for deleting both a P frame and a B frame referring to an I frame to be deleted when deleting the I frame in the first coded video bit stream, and deleting both a P frame and a B frame referring to a P frame to be deleted when deleting the P frames in the first coded video bit stream.

50. The recording medium storing the coded video bit stream processing program of claim 46,
wherein program (a) is for copying an I frame at a close position in the forward direction of the deleted part of frames, in part of the position once occupied by the deleted part of frames.

51. The recording medium storing the coded video bit stream processing program of claim 47,
wherein program (a) is for copying an I frame at a close position in the forward direction of the deleted part of frames, in part of the position once occupied by the deleted part of frames.

52. The recording medium storing the coded video bit stream processing program of claim 48,
wherein program (a) is for copying an I frame at a close position in the forward direction of the deleted part of frames, in part of the position once occupied by the deleted part of frames.

53. The recording medium storing the coded video bit stream processing program of claim 49,
wherein program (a) is for copying an I frame at a close position in the forward direction of the deleted part of frame, in part of the position once occupied by the deleted part of frame.

54. The recording medium storing the coded video bit stream processing program of any one of claims 37 to 42,
wherein program (a) is for deleting the deleted part of frames is deleted at specific intervals.
